(19) United States
(12) Patent Application Publication
(10) Pub. No.: US 2024/0146432 A1
(43) Pub. Date: May 2, 2024

(54) TIME SYNCHRONIZATION COMMUNICATION SYSTEM, TIME SYNCHRONIZATION END STATION, AND MESSAGE TRANSMISSION CONTROL PROGRAM

(71) Applicant: DENSO CORPORATION, Kariya-city (JP)

(72) Inventor: Shinya OKUBO, Kariya-city (JP)

(21) Appl. No.: 18/380,223

(22) Filed: Oct. 16, 2023

(30) Foreign Application Priority Data
Oct. 18, 2022 (JP) 2022-166941

(51) Int. Cl. H04J 3/06

(52) U.S. Cl. CPC H04J 3/0644; H04J 3/065

(57) ABSTRACT

In a time synchronization communication system, a time synchronization end station remotely controls a time synchronization bridge. After transmitting a first message to the time synchronization bridge, the time synchronization end station transmits a second message to the time synchronization bridge on condition that the time synchronization end station has acquired, from the time synchronization bridge, the time held in a time holding section as the first message is received by the time synchronization bridge.

### CROSS REFERENCE TO RELATED APPLICATION

This application is based on Japanese Patent Application No. 2022-166941 filed on Oct. 18, 2022, the disclosure of which is incorporated herein by reference.

### TECHNICAL FIELD

The present disclosure relates to a time synchronization communication system, a time synchronization end station, and a message transmission control program.

### BACKGROUND

A related art discloses a time synchronization communication system in which a time synchronization protocol based on IEEE 802.1 AS is applied to a data communication system for a vehicle.

### SUMMARY

According to one aspect of the present disclosure, a time synchronization end station includes a first time recording section that records a time measured by a first timer at the time of transmission and reception of a message and a message transmission control section that controls transmission of the message. A time synchronization bridge includes a second time recording section that records a time measured by a second timer at the time of transmission and reception of a message and a time holding section that holds a time recorded by the second time recording section, and relays a message transmitted to and received from the time synchronization end station.

### BRIEF DESCRIPTION OF DRAWINGS

The objects, features and advantages of the present disclosure will be more clearly understood from the following detailed description with reference to the accompanying drawings. In the accompanying drawings,

FIG. 1 is a functional block diagram illustrating an overall configuration of a first embodiment;

FIG. 2 is a functional block diagram illustrating configurations of a second ECU and a third ECU;

FIG. 3 is a diagram for explaining the measurement of a propagation delay time;

FIG. 4 is a diagram for explaining the distribution of a reference time;

FIG. 5 is a diagram illustrating a configuration of a register;

FIG. 6 is a diagram illustrating transmission and reception timestamps;

FIG. 7 is a diagram for explaining the distribution of the reference time;

FIG. 8 is a diagram illustrating the transmission and reception timestamps;

FIG. 9 is a diagram illustrating a time chart of a P0 down counter;

FIG. 10A is a flowchart illustrating initialization processing performed by a time synchronization master;

FIG. 10B is a flowchart illustrating the initialization processing performed by the time synchronization master;

FIG. 11 is a diagram for explaining the designation of a transmission port;

FIG. 12 is a diagram for specifying the designation of a reception port;

FIG. 13 is a flowchart illustrating initialization processing performed by a time synchronization slave;

FIG. 14 is a flowchart illustrating down-count processing performed by the time synchronization master;

FIG. 15 is a flowchart illustrating propagation delay time measurement processing performed by the time synchronization slave;

FIG. 16 is a flowchart illustrating propagation delay time measurement processing performed by the time synchronization master;

FIG. 17 is a flowchart illustrating the propagation delay time measurement processing performed by the time synchronization master;

FIG. 18 is a flowchart illustrating reference time distribution processing performed by the time synchronization master;

FIG. 19 is a flowchart illustrating the reference time distribution processing performed by the time synchronization master;

FIG. 20 is a flowchart illustrating processing of computing a time difference of a time synchronization master clock performed by the time synchronization slave;

FIG. 21 is a flowchart illustrating processing of estimating a current time of the time synchronization master clock performed by the time synchronization slave;

FIG. 22 is a functional block diagram illustrating an overall configuration of a comparison target;

FIG. 23 illustrates a second embodiment and is a diagram illustrating a time chart of a P0 transmission permission flag;

FIG. 24A is a flowchart illustrating initialization processing performed by the time synchronization master;

FIG. 24B is a flowchart illustrating the initialization processing performed by the time synchronization master;

FIG. 25 is a flowchart illustrating propagation delay time measurement processing performed by the time synchronization master;

FIG. 26 is a flowchart illustrating the propagation delay time measurement processing performed by the time synchronization master;

FIG. 27 is a flowchart illustrating the propagation delay time measurement processing performed by the time synchronization master;

FIG. 28 is a flowchart illustrating reference time distribution processing performed by the time synchronization master;

FIG. 29 is a flowchart illustrating the reference time distribution processing performed by the time synchronization master;

FIG. 30 illustrates a third embodiment and is a diagram illustrating a configuration of the register;

FIG. 31A is a diagram illustrating a time chart of a P0-Sync down counter;

FIG. 31B is a diagram illustrating a time chart of a P0-Pdelay_Resp down counter;

FIG. 32A is a flowchart illustrating initialization processing performed by the time synchronization master;

FIG. 32B is a flowchart illustrating the initialization processing performed by the time synchronization master;

FIG. 33 is a flowchart illustrating down-count processing performed by the time synchronization master;

FIG. 34 is a flowchart illustrating propagation delay time measurement processing performed by the time synchronization master;

FIG. 35 is a flowchart illustrating the propagation delay time measurement processing performed by the time synchronization master;

FIG. 36 is a flowchart illustrating reference time distribution processing performed by the time synchronization master;

FIG. 37 is a flowchart illustrating the reference time distribution processing performed by the time synchronization master;

FIG. 38A illustrates a fourth embodiment and is a diagram illustrating a time chart of a P0-Sync transmission permission flag;

FIG. 38B illustrates the fourth embodiment and is a diagram illustrating a time chart of a P0-Pdelay_Resp transmission permission flag;

FIG. 39A is a flowchart illustrating initialization processing performed by the time synchronization master;

FIG. 39B is a flowchart illustrating the initialization processing performed by the time synchronization master;

FIG. 40 is a flowchart illustrating propagation delay time measurement processing performed by the time synchronization master;

FIG. 41 is a flowchart illustrating the propagation delay time measurement processing performed by the time synchronization master;

FIG. 42 is a flowchart illustrating reference time distribution processing performed by the time synchronization master;

FIG. 43 is a flowchart illustrating the reference time distribution processing performed by the time synchronization master;

FIG. 44 is a functional block diagram illustrating an overall configuration of a fifth embodiment;

FIG. 45 is a functional block diagram illustrating configurations of the second ECU and the third ECU;

FIG. 46 is a functional block diagram illustrating an overall configuration of a sixth embodiment;

FIG. 47 is a functional block diagram illustrating an overall configuration of a seventh embodiment;

FIG. 48 is a functional block diagram illustrating an overall configuration of an eighth embodiment;

FIG. 49 is a functional block diagram illustrating an overall configuration of a ninth embodiment; and

FIG. 50 is a functional block diagram illustrating a configuration of the third ECU.

### DETAILED DESCRIPTION

For example, in a data communication system for a vehicle mounted on a vehicle, in order to implement an advanced driver assistance system (ADAS) and automated driving, a wide variety of devices such as cameras and sensors are connected to electronic control units (referred to as “ECUs”) arranged in various places of the vehicle. In order to grasp data of these cameras, sensors, and the like in time series, it is necessary to perform time synchronization among a plurality of ECUs connected via a communication network. As a method of performing time synchronization, a time synchronization protocol based on IEEE 1588 (Precision Time Protocol) or IEEE 802.1 AS (gPTP (Generalized Precision Time Protocol)) is being adopted for in-vehicle use.

In a configuration in which a time synchronization master and a time synchronization slave serving as time synchronization end stations perform time synchronization via, for example, Ethernet (registered trademark), a time synchronization bridge compatible with a timestamp of the gPTP standard is disposed between the time synchronization master and the time synchronization slave. The time synchronization bridge has a function of relaying a message transmitted and received between the time synchronization master and the time synchronization slave and transmitting a timestamp indicating the time when the message is transmitted and received to a time synchronization end station. However, in order to implement the function, it is necessary for the time synchronization bridge to have a computation core, software executed by the computation core, dedicated hardware, and the like, and the cost of development and manufacturing of the software and the hardware becomes a problem. In response to such a problem, a method of remotely controlling a time synchronization bridge using a computation core built in a time synchronization end station is specified by AUTOSAR.

In the above configuration, the message transmission and reception timestamps are held in the register of the time synchronization bridge. Here, in the time synchronization bridge, when a message is received from the time synchronization end station, the reception timestamp of the received message is held in the register, and when a new message is subsequently received from the time synchronization end station, the reception timestamp of the received new message is also held in the register. That is, the reception timestamp of the preceding message is overwritten with the reception timestamp of the subsequent message.

In this case, if the time synchronization end station acquires the reception timestamp of the preceding message before the reception timestamp of the preceding message is overwritten with the reception timestamp of the subsequent message, no trouble occurs in time management of messages. However, if the time synchronization end station does not acquire the reception timestamp of the preceding message before the reception timestamp of the preceding message is overwritten with the reception timestamp of the subsequent message, the time synchronization end station cannot acquire the reception timestamp of the preceding message after being overwritten with the reception timestamp of the subsequent message. As a result, a trouble occurs in the time management of messages, and a problem that transmission and reception of messages cannot be appropriately performed newly occurs.

An object of the present disclosure is to provide a time synchronization communication system, a time synchronization end station, and a message transmission control program capable of appropriately transmitting and receiving messages while solving the problem of the cost of development and manufacturing of software and hardware.

According to a first aspect of the present disclosure, a time synchronization end station includes a first time recording section that records a time measured by a first timer at the time of transmission and reception of a message and a message transmission control section that controls transmission of the message. A time synchronization bridge includes a second time recording section that records a time measured by a second timer at the time of transmission and reception of a message and a time holding section that holds a time recorded by the second time recording section, and relays a message transmitted to and received from the time synchronization end station.

The time synchronization end station remotely controls the time synchronization bridge. after transmitting a first message to the time synchronization bridge, the message transmission control section transmits a second message to the time synchronization bridge on condition that the time synchronization end station has acquired, from the time synchronization bridge, a time held in the time holding section as the first message is received by the time synchronization bridge.

In the configuration in which the time synchronization end station remotely controls the time synchronization bridge, after transmitting a first message to the time synchronization bridge, the time synchronization end station transmits a second message to the time synchronization bridge on condition that the time synchronization end station has acquired, from the time synchronization bridge, the time held in the time holding section as the first message is received by the time synchronization bridge. By transmitting the second message to the time synchronization bridge on condition that the time synchronization end station has acquired the time held in the time holding section from the time synchronization bridge, it is possible to avoid the occurrence of the trouble in the time management of messages in advance. With the configuration in which the time synchronization end station remotely controls the time synchronization bridge, it is possible to appropriately transmit and receive messages while solving the problem of the cost of development and manufacturing of software and hardware.

Hereinafter, a plurality of embodiments will be described with reference to the drawings. In subsequent embodiments, descriptions of parts common to the preceding embodiments will be omitted.

### First Embodiment

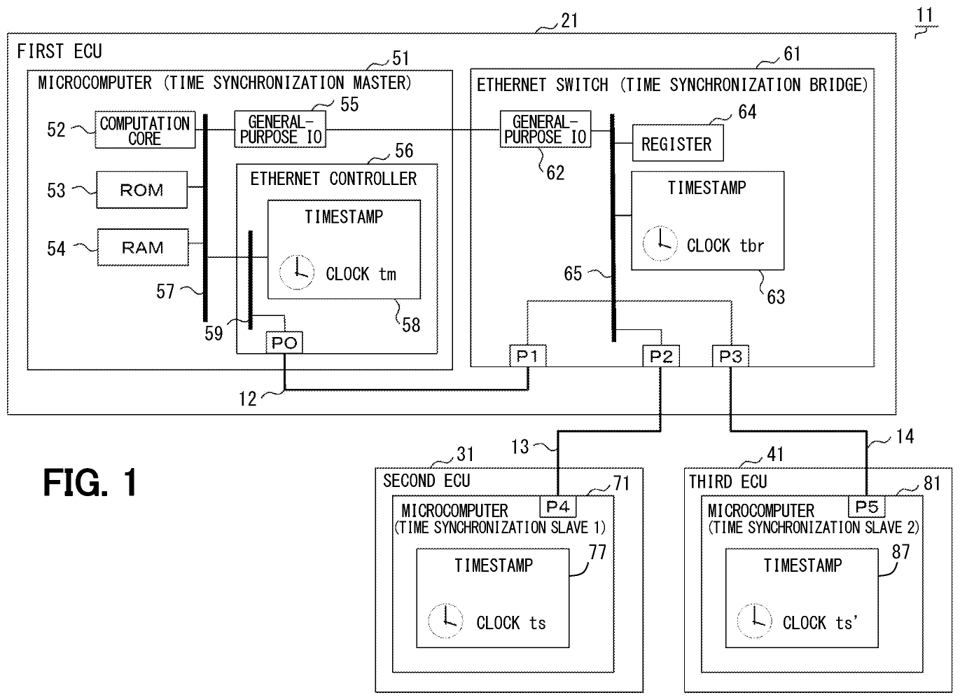

A first embodiment will be described with reference to FIGS. 1 to 22. As illustrated in FIG. 1, a time synchronization communication system 11 includes a first ECU 21, a second ECU 31, and a third ECU 41 as data communication systems for a vehicle. The time synchronization communication system 11 performs data communication to which a time synchronization protocol based on IEEE 802.1 AS (gPTP) is applied, among the first ECU 21, the second ECU 31, and the third ECU 41. In the present embodiment, as will be described later, a configuration in which two time synchronization slaves are connected to a time synchronization master is exemplified, but one or three or more time synchronization slaves may be connected to the time synchronization master.

The first ECU 21 includes a microcomputer 51 and an Ethernet switch 61. The microcomputer 51 is a node that distributes a reference time in the time synchronization communication system 11, and functions as a time synchronization master. The Ethernet switch 61 is a node that relays a message in the time synchronization communication system 11, and functions as a time synchronization bridge. The microcomputer 51 corresponds to “time synchronization station”.

The microcomputer 51 is configured by interconnecting a computation core 52 (corresponding to “transmission control section”), a ROM 53, a RAM 54, a general-purpose IO 55, and an Ethernet controller 56 via a bus 57. The computation core 52 controls the overall operation of the first ECU 21 by performing computation processing. By executing a propagation delay time calculation program, the computation core 52 calculates the propagation delay time between the time synchronization master and the time synchronization bridge, which will be described later. By executing a message transmission control program, the computation core 52 controls the transmission of a message, which will be described later. The ROM 53 is a storage area for storing various data. The RAM 54 is a storage area that functions as a work area when the computation core 52 performs the computation processing. The general-purpose IO 55 performs data communication conforming to a general-purpose communication protocol such as a serial peripheral interface (SP1) with a general-purpose IO to be described later of the Ethernet switch 61.

The Ethernet controller 56 is configured by interconnecting a timestamp section 58 (corresponding to “first time recording section”) and a communication port P0 via a bus 59. The timestamp section 58 includes a timer that measures a clock tm, and records the time measured by the timer. The computation core 52 accesses the timestamp section 58 via the buses 57 and 59, reads the time recorded by the timestamp section 58, and stores the read time in the RAM 54. The Ethernet controller 56 may be configured to transfer the time recorded by the timestamp section 58 to the RAM 54 by a built-in direct memory access (DMA) and store the time. The communication port P0 is connected to a communication port P1, which will be described later, of the Ethernet switch 61 via Ethernet 12. The communication port P0 performs data communication conforming to the Ethernet communication protocol with the communication port P1.

The Ethernet switch 61 is configured by interconnecting a general-purpose IO 62, a timestamp section 63 (corresponding to “second time recording section”), a register 64 (corresponding to “time holding section”), and communication ports P1, P2, and P3 via a bus 65. The general-purpose IO 62 performs data communication conforming to a general-purpose communication protocol with the general-purpose IO 55 of the microcomputer 51. The timestamp section 63 includes a timer that measures a clock tbr, and records the time measured by the timer. The register 64 holds the timestamp recorded by the timestamp section 63.

The communication port P1 performs data communication conforming to the Ethernet communication protocol with the communication port P0 of the microcomputer 51. The communication port P2 is connected to a communication port P4, which will be described later, of the second ECU 31 via Ethernet 13. The communication port P2 performs data communication conforming to the Ethernet communication protocol with the communication port P4. The communication port P3 is connected to a communication port P5, which will be described later, of the third ECU 41 via Ethernet 14. The communication port P3 performs data communication conforming to the Ethernet communication protocol with the communication port P5.

The Ethernet switch 61 does not have a computation core and operates under the control of the computation core 52 of the microcomputer 51. That is, the microcomputer 51 functioning as a time synchronization master writes and reads data to and from the register 64 by the data communication between the general-purpose IOs 55 and 62, and remotely controls the Ethernet switch 61 functioning as a time synchronization bridge.

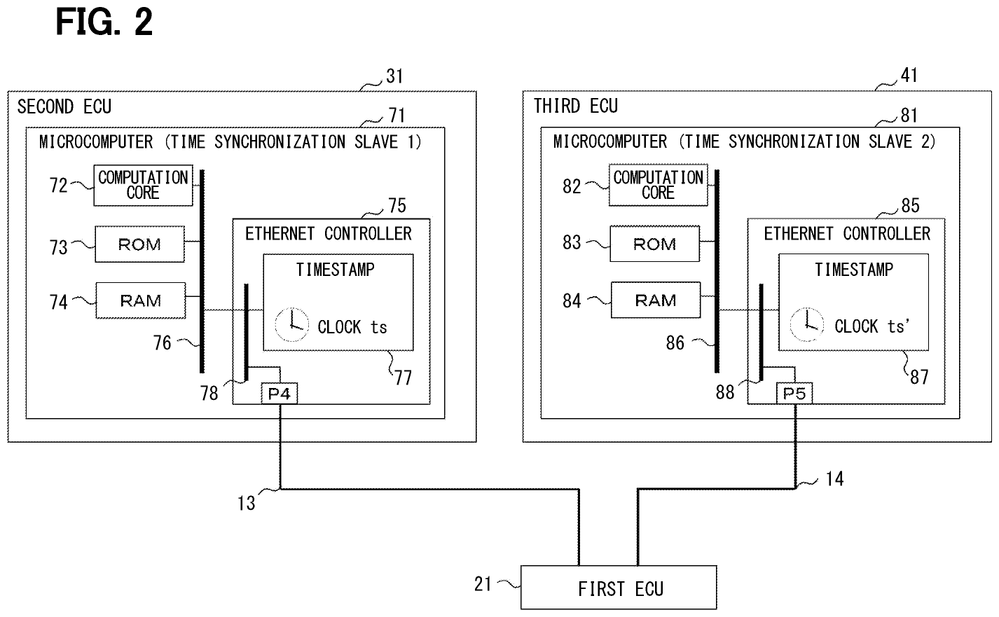

As illustrated in FIG. 2, the second ECU 31 includes a microcomputer 71. The microcomputer 71 is a node that synchronizes with the reference time distributed from the time synchronization master in the time synchronization communication system 11, and functions as a time synchronization slave 1. The microcomputer 71 is configured by interconnecting a computation core 72, a ROM 73, a RAM 74, and an Ethernet controller 75 via a bus 76. The computation core 72 controls the overall operation of the second ECU 31 by performing computation processing. The ROM 73 is a storage area for storing various data. The RAM 74 is a storage area that functions as a work area when the computation core 72 performs the computation processing.

The Ethernet controller 75 is configured by interconnecting a timestamp section 77 and the communication port P4 via a bus 78. The timestamp section 77 includes a timer that measures a clock ts, and records the time measured by the timer. The computation core 72 accesses the timestamp section 77 via the buses 76 and 78, reads the time recorded by the timestamp section 77, and stores the read time in the RAM 74. The Ethernet controller 75 may be configured to transfer the time recorded by the timestamp section 77 to the RAM 74 by a built-in DMA and store the time. The communication port P4 performs data communication conforming to the Ethernet communication protocol with the communication port P2 of the Ethernet switch 61.

The third ECU 41 has a configuration similar to the second ECU 31, and includes a microcomputer 81. The microcomputer 81 is a node that synchronizes with the reference time distributed from the time synchronization master in the time synchronization communication system 11, and functions as a time synchronization slave 2. The microcomputer 81 is configured by interconnecting a computation core 82, a ROM 83, a RAM 84, and an Ethernet controller 85 via a bus 86. The computation core 82 controls the overall operation of the third ECU 41 by performing computation processing. The ROM 83 is a storage area for storing various data. The RAM 84 is a storage area that functions as a work area when the computation core 82 performs the computation processing.

The Ethernet controller 85 is configured by interconnecting a timestamp section 87 and the communication port P5 via a bus 88. The timestamp section 87 includes a timer that measures a clock ts′, and records the time measured by the timer. The computation core 82 accesses the timestamp section 87 via the buses 86 and 88, reads the time recorded by the timestamp section 87, and stores the read time in the RAM 84. The Ethernet controller 85 may be configured to transfer the time recorded by the timestamp section 87 to the RAM 84 by a built-in DMA and store the time. The communication port P5 performs data communication conforming to the Ethernet communication protocol with the communication port P3 of the Ethernet switch 61.

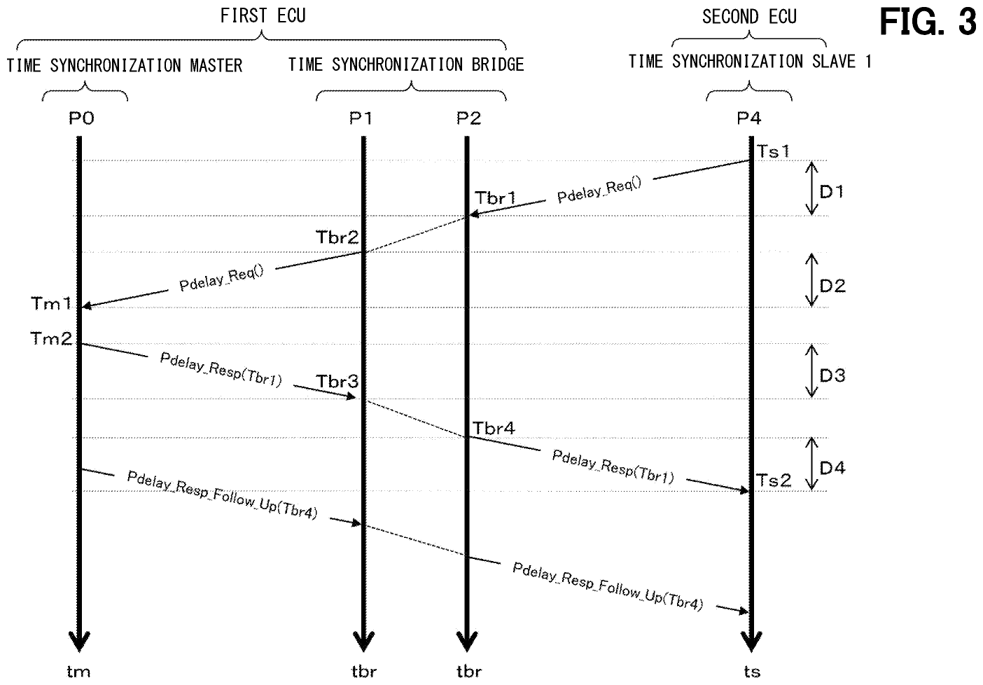

In the above configuration, the time required for the message to pass through the Ethernet 12 between the time synchronization master and the time synchronization bridge, the time required for the message to pass through the Ethernet 13 between the time synchronization slave 1 and the time synchronization bridge, and the time required for the message to pass through the Ethernet 14 between the time synchronization slave 2 and the time synchronization bridge are generated as the propagation delay time. The measurement of the propagation delay time and the distribution of the reference time will be described below. In FIG. 3 and subsequent figures, the relationship between the time synchronization master and the time synchronization slave 1 will be described as an example, but the relationship between the time synchronization master and the time synchronization slave 2 is similar.

(1-1) Measurement of Propagation Delay Time

The measurement of the propagation delay time will be described with reference to FIG. 3.

The time synchronization master, the time synchronization slave, and the time synchronization bridge transmit and receive, as messages for measuring the propagation delay time, a propagation delay measurement request message, a first propagation delay measurement response message, and a second propagation delay measurement response message. The individual messages are as follows.

The propagation delay measurement request message: a message transmitted by the time synchronization slave or the time synchronization bridge to an upper time synchronization bridge or the time synchronization master in order to measure the propagation delay of Ethernet to which the time synchronization slave or the time synchronization bridge is connected. In FIG. 3 and subsequent figures, it is indicated as “Pdelay_Req (Propagation delay Request)”.

The first propagation delay measurement response message: a message in which the time synchronization master that has received the propagation delay measurement request message stores a reception timestamp indicating the time when the propagation delay measurement request message is received by the time synchronization bridge, and that is transmitted to the transmission source of the propagation delay measurement request message. In FIG. 3 and subsequent figures, it is indicated as “Pdelay_Resp (Propagation delay Response)”.

The second propagation delay measurement response message: a message in which the time synchronization master that has transmitted the first propagation delay measurement response message stores a transmission timestamp indicating the time when the first propagation delay measurement response message is transmitted from the time synchronization bridge, and that is transmitted to the transmission source of the propagation delay measurement request message. In FIG. 3 and subsequent figures, it is indicated as “Pdelay_Resp_Follow_Up”.

As illustrated in FIG. 3, in a case where the microcomputer 51 as the time synchronization master, the microcomputer 71 as the time synchronization slave 1, and the Ethernet switch 61 as the time synchronization bridge perform time synchronization, timestamps are as follows.

Ts1: a transmission timestamp indicating the time when the propagation delay measurement request message is transmitted from the communication port P4.

Tbr1: a reception timestamp indicating the time when the propagation delay measurement request message passes through the communication port P2 and the time when the propagation delay measurement request message is received by the communication port P2.

Tbr2: a transmission timestamp indicating the time when the propagation delay measurement request message passes through the communication port P1 and the time when the propagation delay measurement request message is transmitted from the communication port P1.

Tm1: a reception timestamp indicating the time when the propagation delay measurement request message is received by the communication port P0.

Tm2: a transmission timestamp indicating the time when the first propagation delay measurement response message is transmitted from the communication port P0.

Tbr3: a reception timestamp indicating the time when the first propagation delay measurement response message passes through the communication port P1 and the time when the first propagation delay measurement response message is received by the communication port P1.

Tbr4: a transmission timestamp indicating the time when the first propagation delay measurement response message passes through the communication port P2 and the time when the first propagation delay measurement response message is transmitted from the communication port P2.

Ts2: a reception timestamp indicating the time when the first propagation delay measurement response message is received by the communication port P4.

D1: the time from Ts1 to Tbr1, and the propagation delay time between the time synchronization slave 1 and the time synchronization bridge.

D2: the time from Tbr2 to Tm1, and the propagation delay time between the time synchronization master and the time synchronization bridge.

D3: the time from Tm2 to Tbr3, and the propagation delay time between the time synchronization master and the time synchronization bridge.

D4: the time from Tbr4 to Ts2, and the propagation delay time between the time synchronization slave 1 and the time synchronization bridge.

In this case, for the propagation delay time between the time synchronization slave 1 and the time synchronization bridge,

$$\\ D 1 = D 4 = ( D 1 + D 4 ) / 2 = [ ( Ts 2 - Ts 1 ) - ( Tbr 4 - Tbr 1 ) ] / 2 … ( arithmetic expression 1 ) holds .$$

The time synchronization slave 1 acquires Ts1 and Ts2 by itself. Since Tbr1 is stored in the first propagation delay measurement response message received from the time synchronization master via the time synchronization bridge, when receiving the first propagation delay measurement response message, the time synchronization slave 1 extracts and acquires Tbr1 from the received first propagation delay measurement response message. Since Tbr4 is stored in the second propagation delay measurement response message received from the time synchronization master via the time synchronization bridge, when receiving the second propagation delay measurement response message, the time synchronization slave 1 extracts and acquires Tbr4 from the received second propagation delay measurement response message. The time synchronization slave 1 acquires Ts1, Ts2, Tbr1, and Tbr4, and calculates D1 (=D4) by arithmetic expression 1.

Furthermore, for the propagation delay time between the time synchronization master and the time synchronization bridge,

$$\\ D 2 = D 3 = ( D 2 + D 3 ) / 2 = [ ( Tbr 3 - Tbr 2 ) - ( Tm 2 - Tm 1 ) ] / 2 … ( arithmetic expression 2 ) holds .$$

The time synchronization master acquires Tm1 and Tm2 by itself. The time synchronization master acquires Tbr2 and Tbr3 from the time synchronization bridge by the data communication between the general-purpose IOs 55 and 62. The time synchronization master acquires Tm1, Tm2, Tbr2, and Tbr3, and calculates D2 (=D3) by arithmetic expression 2.

(1-2) Distribution of Reference Time

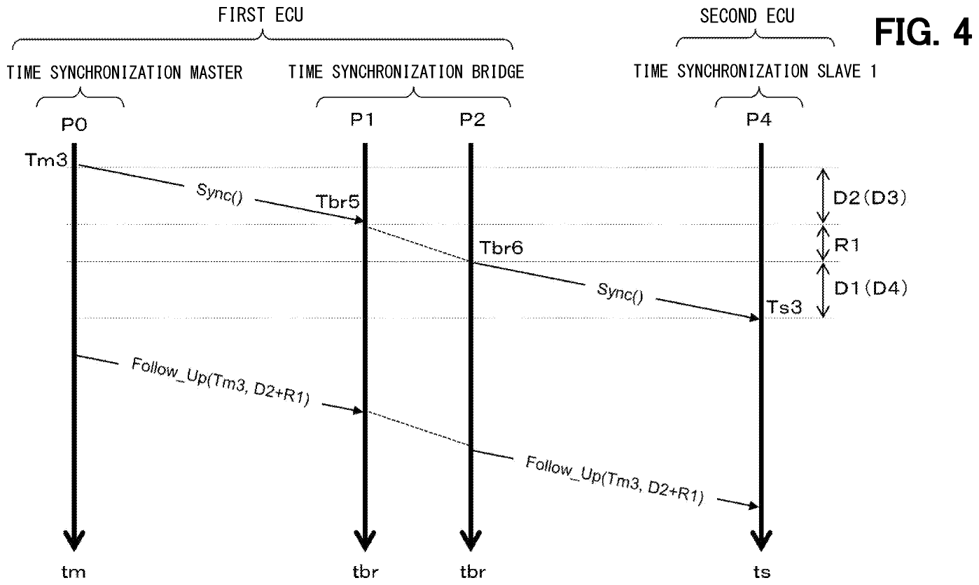

The distribution of the reference time will be described with reference to FIG. 4.

The time synchronization master, the time synchronization slave, and the time synchronization bridge transmit and receive a first synchronization message and a second synchronization message as messages for distributing the reference time. The individual messages are as follows.

The first synchronization message: a message transmitted by the time synchronization master to a lower time synchronization bridge or time synchronization slave in order to distribute the reference time of the time synchronization master. In FIG. 4 and the subsequent figures, it is indicated as “Sync”.

The second synchronization message: a message in which the time synchronization master stores the transmission time of the first synchronization message, the propagation delay time between the time synchronization master and the time synchronization bridge, and the residence time of the first synchronization message in the time synchronization bridge, and that is transmitted to the lower time synchronization bridge or time synchronization slave. In FIG. 4 and subsequent figures, it is indicated as “Follow_Up”.

As illustrated in FIG. 4, in a case where the microcomputer 51 as the time synchronization master, the microcomputer 71 as the time synchronization slave 1, and the Ethernet switch 61 as the time synchronization bridge perform time synchronization, timestamps are as follows.

Tm3: a transmission timestamp indicating the time when the first synchronization message is transmitted from the communication port P0.

Tbr5: a reception timestamp indicating the time when the first synchronization message passes through the communication port P1 and the time when the first synchronization message is received by the communication port P1.

Tbr6: a transmission timestamp indicating the time when the first synchronization message passes through the communication port P2 and the time when the first synchronization message is transmitted from the communication port P2.

Ts3: a reception timestamp indicating the time when the first synchronization message is received by the communication port P4.

R1: the time from Tbr5 to Tbr6, the time required for the first synchronization message to pass through the time synchronization bridge, and the residence time of the first synchronization message in the time synchronization bridge.

Assuming that the time difference between the clock tm of the time synchronization master and the clock is of the time synchronization slave 1 is denoted by “C”,

$$\\ C = Ts 3 - ( Tm 3 + D 2 + R 1 + D 1 ) … ( arithmetic expression 3 ) holds , and$$

$$\\ tm = ts - C = ts - [ Ts 3 - ( Tm 3 + D 2 + R 1 + D 1 ) ] = ts - Ts 3 + Tm 3 + D 2 + R 1 + D 1 … ( arithmetic expression 4 )$$

$$\\ R 1 = Tbr 6 - Tbr 5 … ( arithmetic expression 5 ) holds .$$

The time synchronization slave 1 acquires Ts3 by itself. Since Tm3 and D2+R1 are stored in the second synchronization message received from the time synchronization master via the time synchronization bridge, when receiving the second synchronization message, the time synchronization slave 1 extracts and acquires Tm3 and D2+R1 from the received second synchronization message. Tm3 and D2+R1 are stored in different fields of the second synchronization message. The time synchronization slave 1 acquires Ts3, Tm3, and D2+R1, and estimates the clock tm of the time synchronization master by arithmetic expression 4.

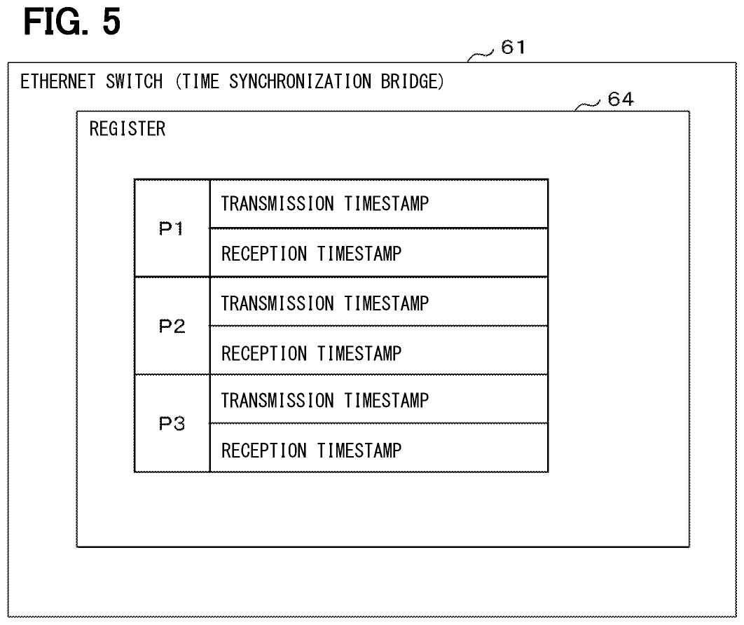

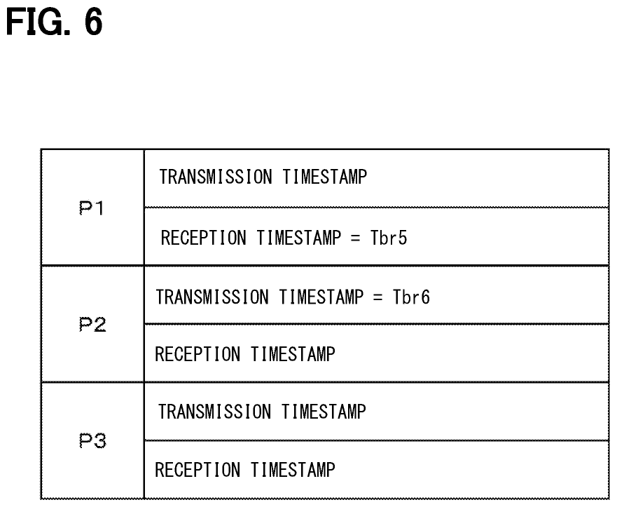

As described above, in the configuration in which the time synchronization bridge transmits the message received from the time synchronization master to the time synchronization slave, the transmission and reception timestamps recorded by the timestamp section 63 are held in the register 64. As illustrated in FIG. 5, the register 64 has a transmission timestamp holding area and a reception timestamp holding area for each of the communication ports P1, P2, and P3. In the time synchronization bridge, in a case where the first synchronization message transmitted from the time synchronization master is received by the communication port P1 and the received first synchronization message is transmitted from the communication port P2 to the time synchronization slave 1, as illustrated in FIG. 6, Tbr5 is held in the reception timestamp holding area of the communication port P1, and Tbr6 is held in the transmission timestamp holding area of the communication port P2.

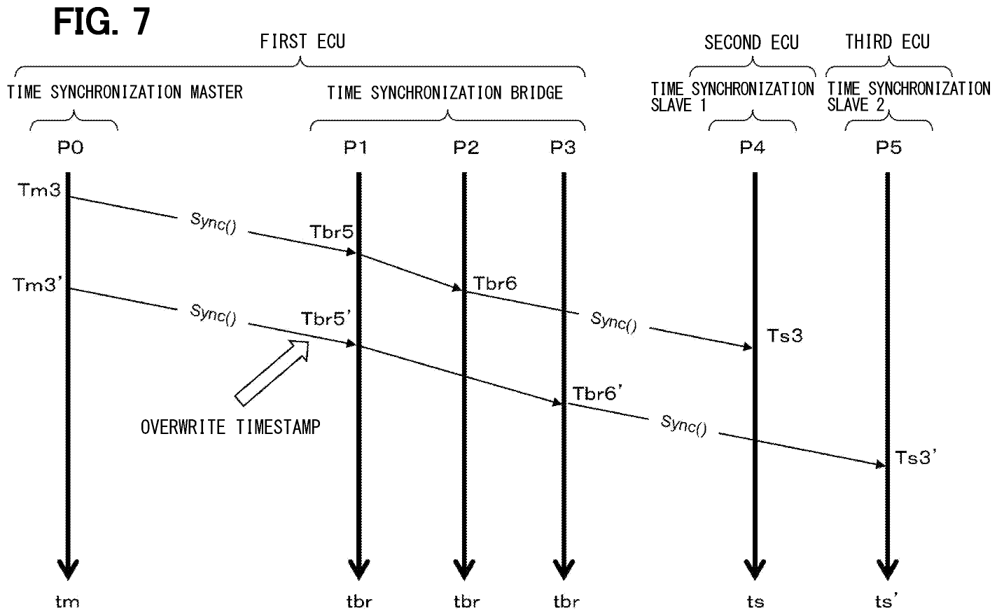

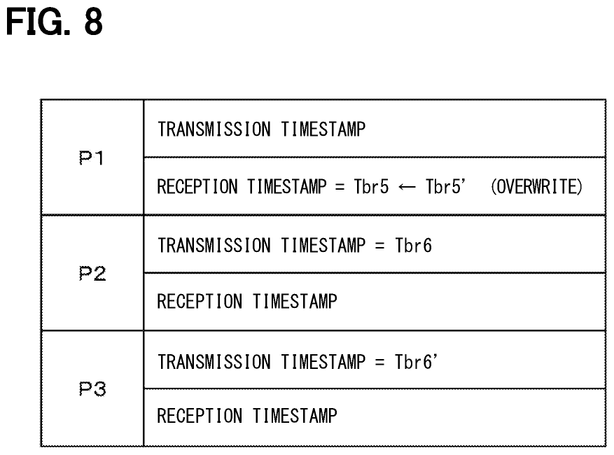

As illustrated in FIG. 7, it is assumed that the time synchronization master transmits the first synchronization message (corresponding to the first message) addressed to the time synchronization slave 1 to the time synchronization slave 1, and subsequently transmits the first synchronization message (corresponding to the second message) addressed to the time synchronization slave 2. In this case, as illustrated in FIG. 8, Tbr5 is held in the reception timestamp holding area of the communication port P1, Tbr6 is held in the transmission timestamp holding area of the communication port P2, subsequently Tbr5′ is held in the reception timestamp holding area of the communication port P1, and Tbr6′ is held in the transmission timestamp holding area of the communication port P3. That is, in the reception timestamp holding area of the communication port P1, the reception timestamp Tbr5 of the preceding message is overwritten with the reception timestamp Tbr5′ of the subsequent message.

If the time synchronization master acquires the reception timestamp Tbr5 of the preceding message before the reception timestamp Tbr5 of the preceding message is overwritten with the reception timestamp Tbr5′ of the subsequent message, no trouble occurs in the time management of messages. However, if the time synchronization master does not acquire the reception timestamp Tbr5 of the preceding message before the reception timestamp Tbr5 of the preceding message is overwritten with the reception timestamp Tbr5′ of the subsequent message, the time synchronization master cannot acquire the reception timestamp of the preceding message after being overwritten with the reception timestamp Tbr5′ of the subsequent message, which causes a trouble in the time management of messages. Not only in the case where the time synchronization master transmits the first synchronization message, but also in the case where the time synchronization master transmits the first propagation delay measurement response message, a trouble also occurs in the time management of messages.

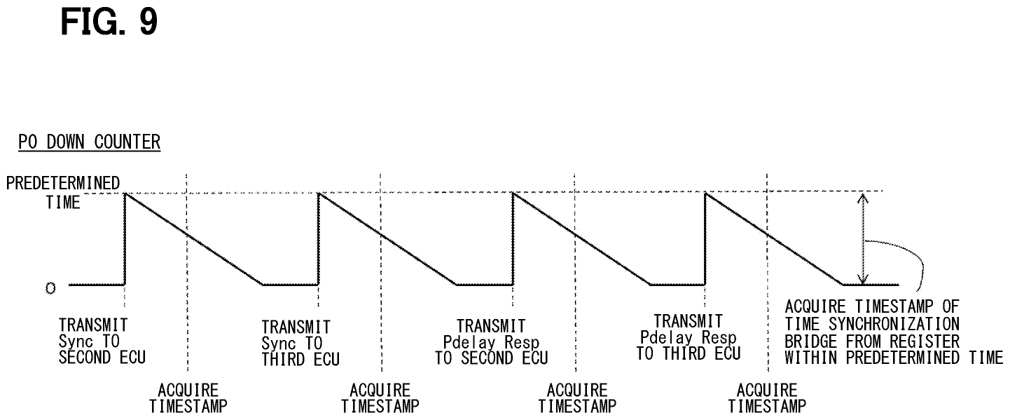

In this regard, in the time synchronization master, the computation core 52 controls the transmission of a message from the communication port P0, and avoids a trouble caused by overwriting the reception timestamp of the register 64. Specifically, as illustrated in FIG. 9, the computation core 52 includes a P0 down counter as a communication port P0 counter that measures a predetermined time, and sets the time during which the reception timestamp held in the register 64 can be acquired as the predetermined time. The predetermined time is, for example, four milliseconds, and in the P0 down counter, one LSB is one millisecond, for example.

The computation core 52 prohibits the transmission of the message while the P0 down counter is counting, and permits the transmission of the message while the P0 down counter stops counting. When the message transmission request event is established, the computation core 52 sets the predetermined time in the P0 down counter, causes the P0 down counter to start counting, and transmits the message from the time synchronization master to the time synchronization bridge.

The computation core 52 waits for the establishment of a new message transmission request event after starting the counting of the P0 down counter, but does not transmit the new message from the time synchronization master to the time synchronization bridge as long as the counting of the P0 down counter is continued even if the new message transmission request event is established. When the P0 down counter terminates counting, if the new message transmission request event is established, the computation core 52 starts the counting of the P0 down counter again, and transmits the new message from the time synchronization master to the time synchronization bridge. The computation core 52 repeats the processing. An up counter may be used instead of the down counter.

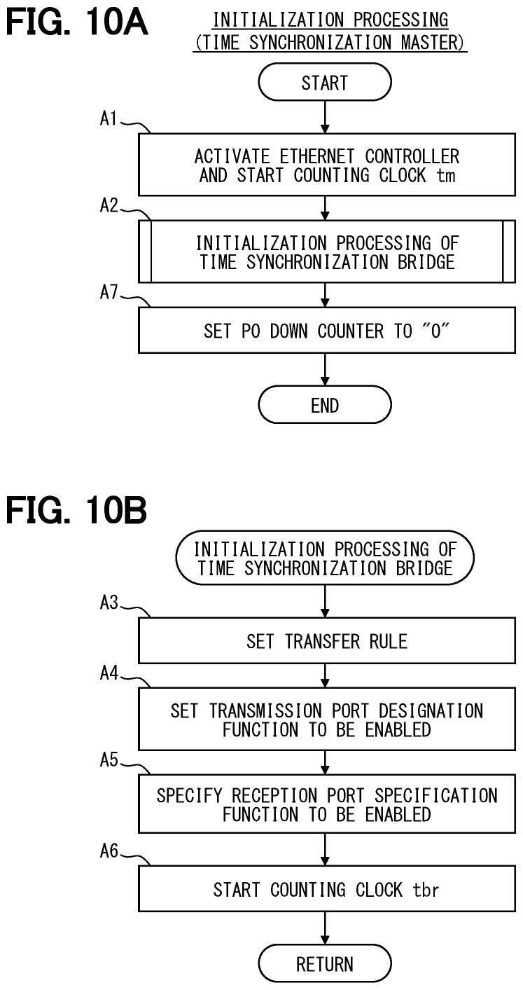

Next, the operation of the above configuration will be described with reference to FIGS. 10A to 22. Here, the initialization processing performed by the time synchronization master, the initialization processing performed by the time synchronization slave 1, the down-count processing performed by the time synchronization master, the propagation delay time measurement processing performed by the time synchronization slave 1, the propagation delay time measurement processing performed by the time synchronization master, the reference time distribution processing performed by the time synchronization master, the processing of computing the time difference of the time synchronization master clock performed by the time synchronization slave 1, and the processing of estimating the current time of the time synchronization master clock performed by the time synchronization slave 1 will be sequentially described. In FIG. 10A and subsequent figures, the processing performed by the time synchronization slave 1 will be described as an example, but the processing performed by the time synchronization slave 2 is similar.

(1-11) Initialization Processing Performed by Time Synchronization Master (see FIGS. 10A to 12)

In the time synchronization master, when the initialization processing is started, the computation core 52 activates the Ethernet controller 56 and starts counting the clock tm (A1). The computation core 52 outputs an initialization command from the general-purpose IO 55 to the Ethernet switch 61, and shifts to the initialization processing of the time synchronization bridge (A2).

When the initialization processing of the time synchronization bridge is started, the computation core 52 sets a transfer rule (A3). The computation core 52 sets the register 64 so as to transfer the message related to time synchronization received from the communication port P2 or the communication port P3 to the communication port P0. The message related to time synchronization is a propagation delay measurement request message, a first propagation delay measurement response message, a second propagation delay measurement response message, a first synchronization message, or a second synchronization message.

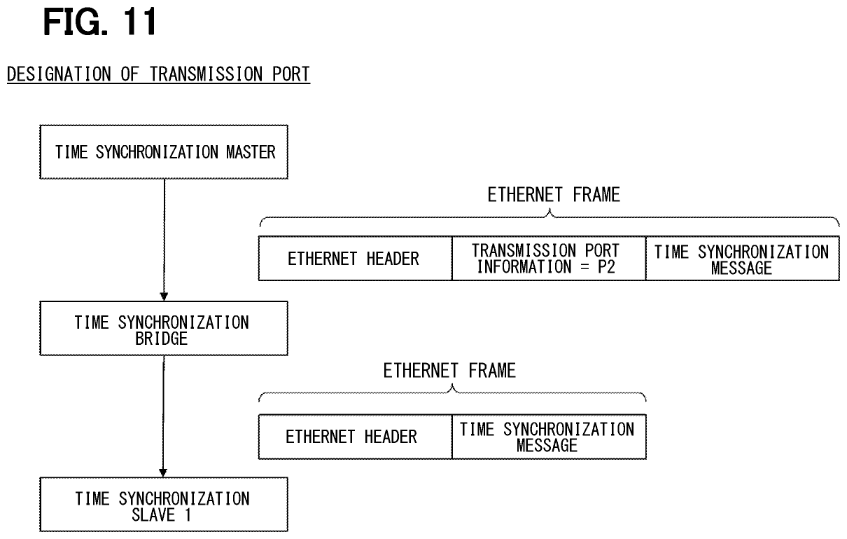

The computation core 52 sets the transmission port designation function of the register 64 to be enabled (A4). When transmitting the message related to time synchronization from the communication port P2 or the communication port P3, the computation core 52 assigns transmission port information designating the communication port to the Ethernet frame storing the message related to time synchronization. In a case where the transmission port designation function of the register 64 is enabled, the Ethernet switch 61 identifies the transmission port information assigned to the message related to time synchronization received from the communication port P1, and transmits the Ethernet frame from which the identified transmission port information has been deleted from the communication port indicated by the transmission port information. FIG. 11 illustrates a change in the Ethernet frame in a case where the message related to time synchronization is transmitted from the communication port P2. According to IEEE 802.1 AS, a unique value “01-80-C2-00-00-0E” is designated as the destination MAC address of the Ethernet frame that stores the message related to time synchronization regardless of the transmission port. In the transfer rule of the Ethernet switch 61, the communication port P2 or the communication port P3 as the transmission destination cannot be identified from the unique destination MAC address, and thus the transmission port designation function is used as described above.

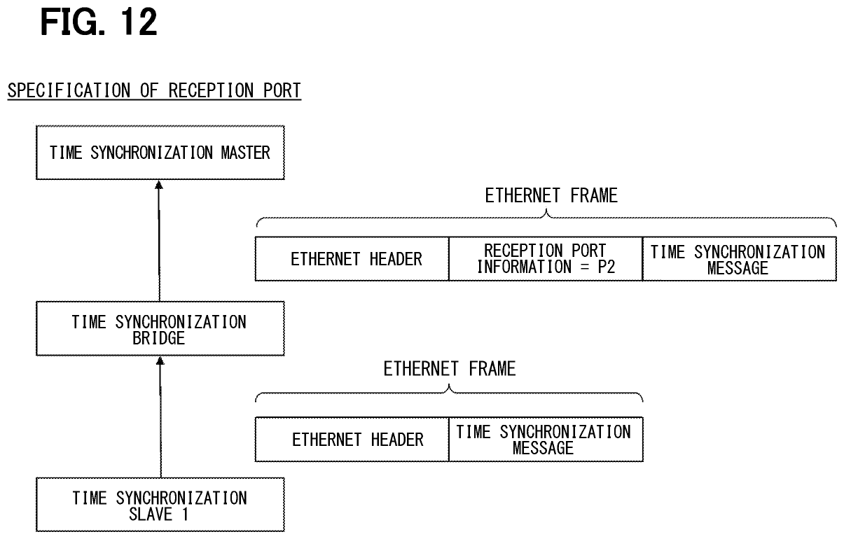

The computation core 52 sets the reception port specification function of the register 64 to be enabled (A5). In a case where the reception port specification function of the register 64 is enabled, the Ethernet switch 61 assigns reception port information indicating the communication port having received to the Ethernet frame that stores the message related to time synchronization received from the communication port P2 or the communication port P3, and transmits the Ethernet frame from the communication port 1. The computation core 52 specifies the time synchronization slave as the transmission source from the reception port information. FIG. 12 illustrates a change in the Ethernet frame in a case where the message related to time synchronization is received from the communication port P2. The computation core 52 starts counting the clock tbr (A6), returns to the initialization processing, sets the P0 down counter to “0” (A7), and terminates the initialization processing.

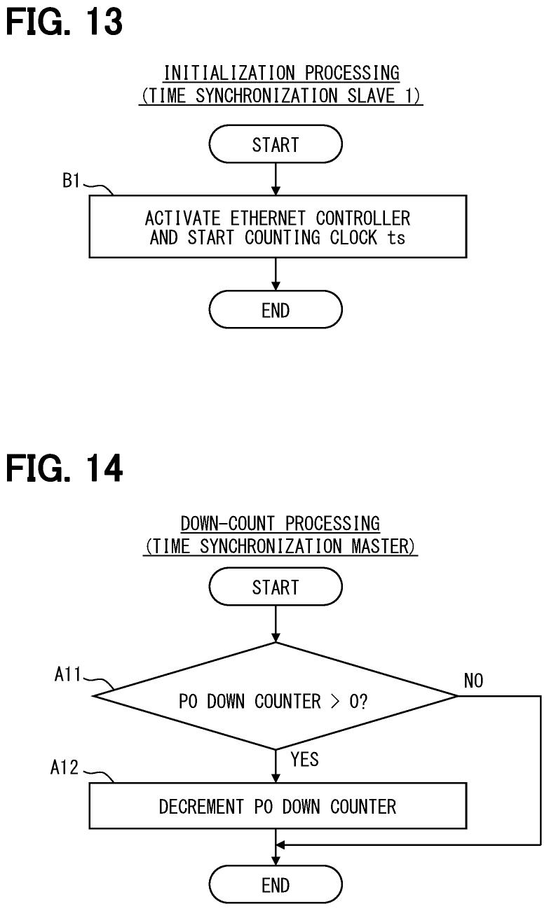

(1-12) Initialization Processing Performed by Time Synchronization Slave 1 (see FIG. 13)

In the time synchronization slave 1, when the initialization processing is started, the computation core 72 activates the Ethernet controller 75, starts counting the clock is (B1), and terminates the initialization processing.

(1-13) Down-Count Processing Performed by Time Synchronization Master (see FIG. 14)

In the time synchronization master, the computation core 52 performs down-count processing every predetermined cycle (for example, one millisecond) determined in advance. When the down-count processing is started, the computation core 52 determines whether or not the count value of the P0 down counter exceeds “0” (A11). When determining that the count value of the P0 down counter does not exceed “0” (A11: NO), that is, when determining that the counting of the P0 down counter is being stopped, the computation core 52 terminates the down-count processing.

When determining that the count value of the P0 down counter exceeds “0” (A11: YES), that is, when determining that the counting of the P0 down counter is being performed, the computation core 52 decrements the count value of the P0 down count (A12), and terminates the down-count processing. In a case where the P0 down counter is implemented by a hardware timer, the down-count processing performed by the computation core 52 is unnecessary. In addition, in a case where an up counter is used instead of the down counter, the computation core 52 increments the count value of the P0 up counter when determining that the counting of the P0 up counter is being performed.

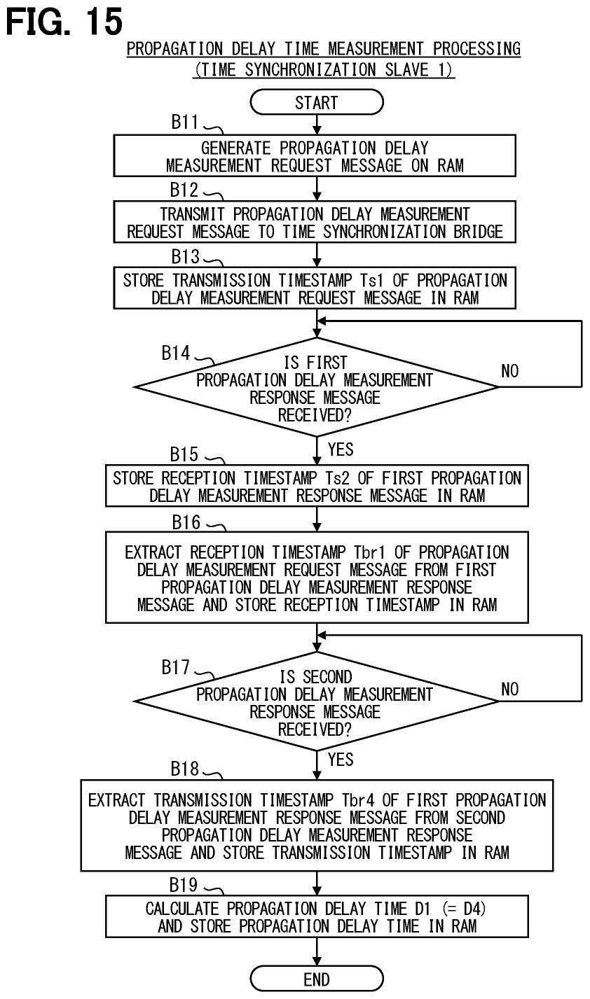

(1-14) Propagation Delay Time Measurement Processing Performed by Time Synchronization Slave 1 (See FIG. 15)

In the time synchronization slave 1, the computation core 72 performs propagation delay time measurement processing every transmission cycle (for example, one second) of the propagation delay measurement request message determined in advance. When the propagation delay time measurement processing is started, the computation core 72 generates a propagation delay measurement request message on the RAM 74 (B11). The computation core 72 transmits the propagation delay measurement request message to the time synchronization bridge (B12). The computation core 72 stores the transmission timestamp Ts1 of the propagation delay measurement request message in the RAM 74 (B13). The computation core 72 waits for receiving the first propagation delay measurement response message from the time synchronization bridge (B14).

When determining that the first propagation delay measurement response message is received from the time synchronization bridge (B14: YES), the computation core 72 stores the reception timestamp Ts2 of the first propagation delay measurement response message in the RAM 74 (B15). The computation core 72 extracts the reception timestamp Tbr1 when the propagation delay measurement request message is received by the communication port P2 from the first propagation delay measurement response message and stores the reception timestamp Tbr1 in the RAM 74 (B16). The computation core 72 waits for receiving the second propagation delay measurement response message from the time synchronization bridge (B17).

When determining that the second propagation delay measurement response message is received from the time synchronization bridge (B17: YES), the computation core 72 extracts the transmission timestamp Tbr4 when the first propagation delay measurement response message is transmitted from the communication port P2 from the second propagation delay measurement response message and stores the transmission timestamp Tbr4 in the RAM 74 (B18). The computation core 72 reads Ts1, Ts2, Tbr1, and Tbr4 stored in the RAM 74, calculates D1 (=D4) by arithmetic expression 1, stores D1 (=D4) in the RAM 74 (B19), and terminates the propagation delay time measurement processing.

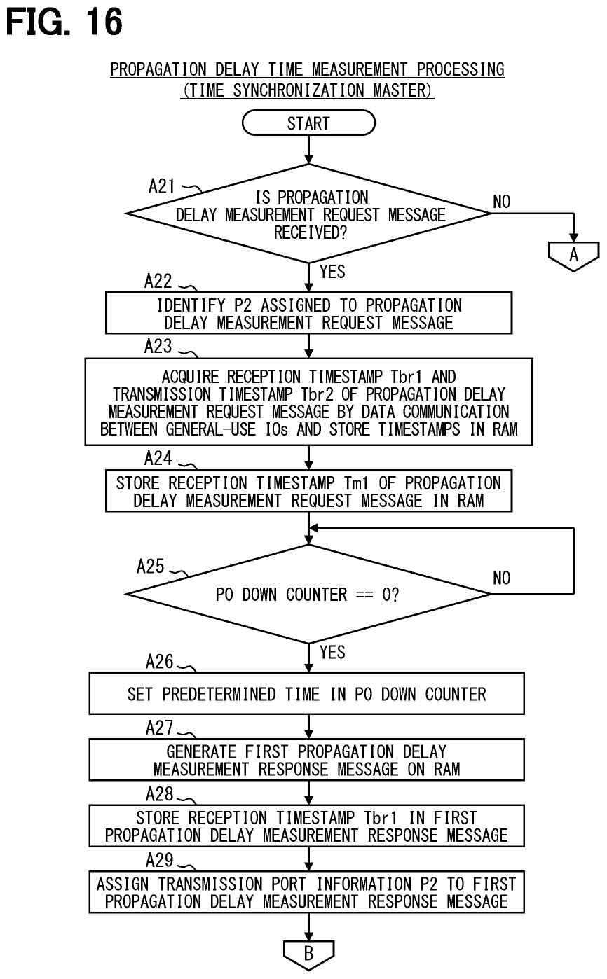

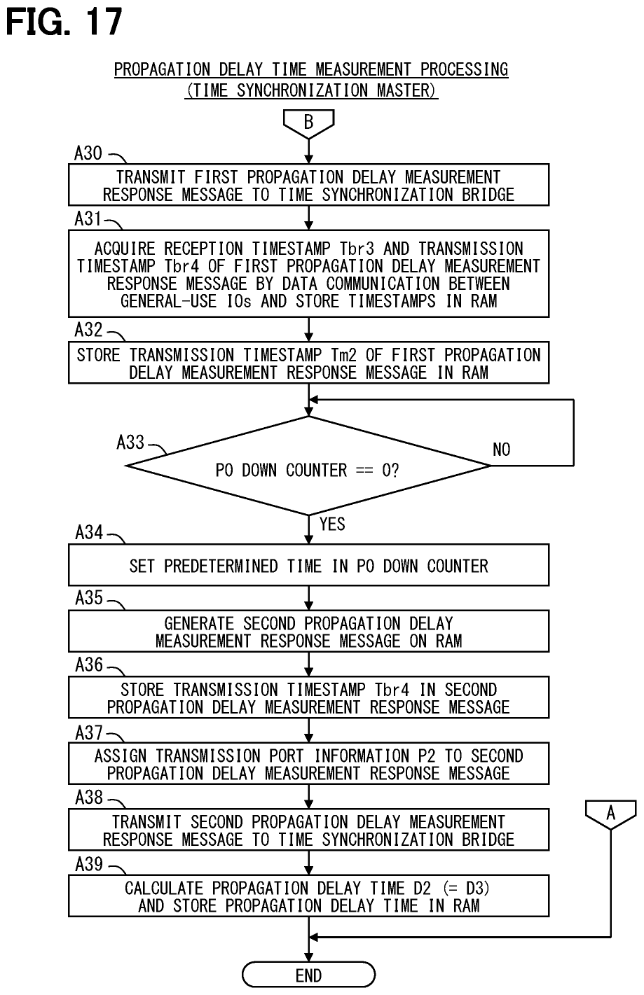

(1-15) Propagation Delay Time Measurement Processing Performed by Time Synchronization Master (See FIGS. 16 to 17)

In the time synchronization master, the computation core 52 performs propagation delay time measurement processing every reception determination cycle (for example, one millisecond) of the propagation delay measurement request message determined in advance by interruption. When the propagation delay time measurement processing is started, the computation core 52 determines whether the propagation delay measurement request message is received from the time synchronization bridge (A21). When determining that the propagation delay measurement request message is not received from the time synchronization bridge (A21: NO), the computation core 52 terminates the propagation delay time measurement processing.

When determining that the propagation delay measurement request message is received from the time synchronization bridge (A21: YES), the computation core 52 identifies that the reception port information assigned to the propagation delay measurement request message is the communication port P2 (A22). The computation core 52 acquires the reception timestamp Tbr1 when the propagation delay measurement request message is received by the communication port P2 and the transmission timestamp Tbr2 when the propagation delay measurement request message is transmitted from the communication port P1 by the data communication between the general-purpose IOs 55 and 62, and stores the timestamps in the RAM 54 (A23). The computation core 52 stores the reception timestamp Tm1 of the propagation delay measurement request message in the RAM 54 (A24).

The computation core 52 determines whether or not the count value of the P0 down counter is “0” (A25). When determining that the count value of the P0 down counter is not “0” (A25: NO), the computation core 52 stands by until the count value of the P0 down counter reaches “0”. When determining that the count value of the P0 down counter is “0” (A25: YES), the computation core 52 sets the count value of the P0 down counter to the predetermined time (A26).

The computation core 52 generates the first propagation delay measurement response message on the RAM 54 (A27). The computation core 52 stores the reception timestamp Tbr1 of the propagation delay measurement request message in the first propagation delay measurement response message (A28). The computation core 52 assigns the communication port P2 to the first propagation delay measurement response message as transmission port information (A29). The computation core 52 transmits the first propagation delay measurement response message to the time synchronization bridge (A30, corresponding to “first message transmission procedure”).

The computation core 52 acquires the reception timestamp Tbr3 when the first propagation delay measurement response message is received by the communication port P1 and the transmission timestamp Tbr4 when the first propagation delay measurement response message is transmitted from the communication port P2 by the data communication between the general-purpose IOs 55 and 62, and stores the timestamps in the RAM 54 (A31). The computation core 52 stores the transmission timestamp Tm2 of the first propagation delay measurement response message in the RAM 54 (A32).

The computation core 52 determines whether or not the count value of the P0 down counter is “0” (A33). When determining that the count value of the P0 down counter is not “0” (A33: NO), the computation core 52 stands by until the count value of the P0 down counter reaches “0”. When determining that the count value of the P0 down counter is “0” (A33: YES), the computation core 52 sets the count value of the P0 down counter to the predetermined time (A34).

The computation core 52 generates the second propagation delay measurement response message on the RAM 54 (A35). The computation core 52 stores the transmission timestamp Tbr4 of the first propagation delay measurement response message in the second propagation delay measurement response message (A36). The computation core 52 assigns the communication port P2 to the second propagation delay measurement response message as the transmission port information (A37). The computation core 52 transmits the second propagation delay measurement response message to the time synchronization bridge (A38, corresponding to “second message transmission procedure”). That is, the computation core 52 transmits the second propagation delay measurement response message to the time synchronization bridge on condition that the time synchronization master has acquired the reception timestamps of all the time synchronization messages including the first propagation delay measurement response message held in the register 64 from the time synchronization bridge.

The computation core 52 reads Tm1, Tm2, Tbr2, and Tbr3 stored in the RAM 54, calculates D2 (=D3) by arithmetic expression 2, stores D2 (=D3) in the RAM 54 (A39), and terminates the propagation delay time measurement processing.

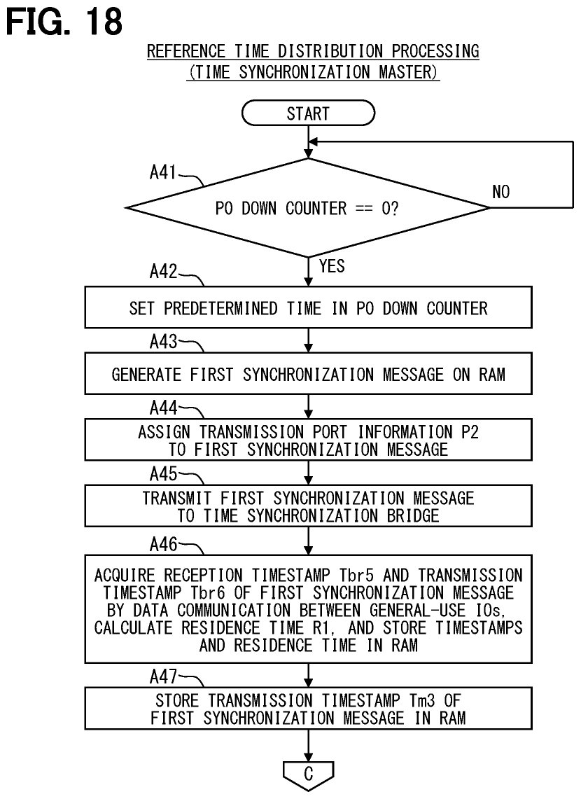

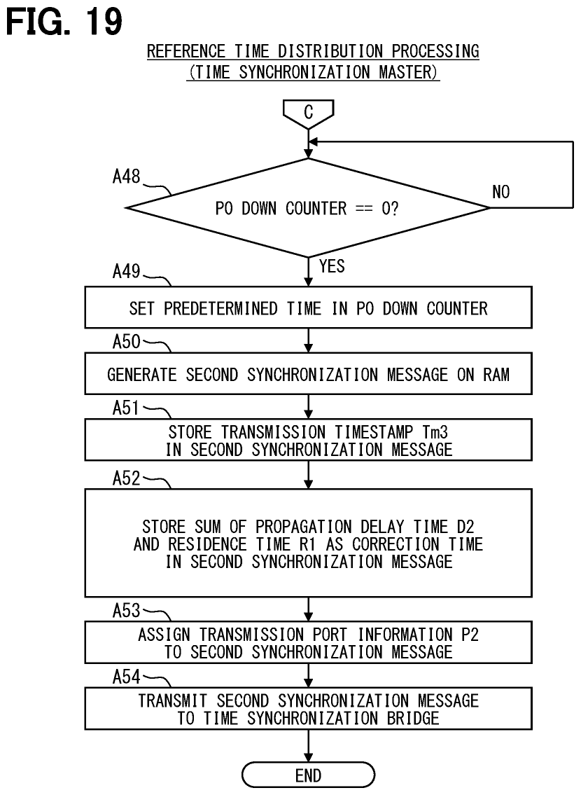

(1-16) Reference Time Distribution Processing Performed by Time Synchronization Master (See FIGS. 18 to 19)

In the time synchronization master, the computation core 52 performs the reference time distribution processing every transmission cycle (for example, 125 milliseconds) of the first synchronization message determined in advance. When the reference time distribution processing is started, the computation core 52 determines whether or not the count value of the P0 down counter is “0” (A41). When determining that the count value of the P0 down counter is not “0” (A41: NO), the computation core 52 stands by until the count value of the P0 down counter reaches “0”. When determining that the count value of the P0 down counter is “0” (A41: YES), the computation core 52 sets the count value of the P0 down counter to the predetermined time (A42).

The computation core 52 generates the first synchronization message on the RAM 54 (A43). The computation core 52 assigns the communication port P2 to the first synchronization message as the transmission port information (A44). The computation core 52 transmits the first synchronization message to the time synchronization bridge (A45, corresponding to “first message transmission procedure”).

The computation core 52 acquires the reception timestamp Tbr5 when the first synchronization message is received by the communication port P1 and the transmission timestamp Tbr6 when the first synchronization message is transmitted from the communication port P2 by the data communication between the general-purpose IOs 55 and 62, calculates the residence time R1 of the first synchronization message in the time synchronization bridge, and stores the residence time R1 in the RAM 54 (A46). The computation core 52 stores the transmission timestamp Tm3 of the first synchronization message in the RAM 54 (A47).

The computation core 52 determines whether or not the count value of the P0 down counter is “0” (A48). When determining that the count value of the P0 down counter is not “0” (A48: NO), the computation core 52 stands by until the count value of the P0 down counter reaches “0”. When determining that the count value of the P0 down counter is “0” (A48: YES), the computation core 52 sets the count value of the P0 down counter to the predetermined time (A49).

The computation core 52 generates the second synchronization message on the RAM 54 (A50). The computation core 52 stores the transmission timestamp Tm3 of the first synchronization message in the second synchronization message (A51). The computation core 52 stores the sum of the propagation delay time D2 and the residence time R1 as the correction time in the second synchronization message (A52). The computation core 52 assigns the communication port P2 to the second synchronization message as the transmission port information (A53). The computation core 52 transmits the second synchronization message to the time synchronization bridge (A54, corresponding to “second message transmission procedure”), and terminates the reference time distribution processing. That is, the computation core 52 transmits the second synchronization message to the time synchronization bridge on condition that the time synchronization master has acquired the reception timestamps of all the time synchronization messages including the first synchronization message held in the register 64 from the time synchronization bridge.

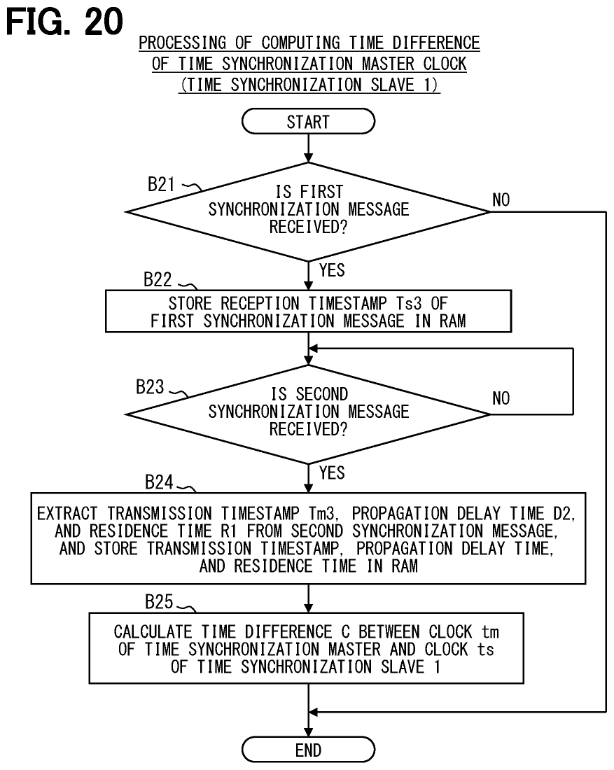

(1-17) Processing of Computing Time Difference of Time Synchronization Master Clock Performed by Time Synchronization Slave 1 (See FIG. 20)

In the time synchronization slave 1, the computation core 72 performs the processing of computing the time difference of the time synchronization master clock every reception determination cycle (for example, one millisecond) of the first synchronization message determined in advance or by interruption. When the processing of computing the time difference of the time synchronization master clock is started, the computation core 72 determines whether the first synchronization message is received from the time synchronization bridge (B21). When determining that the first synchronization message is not received from the time synchronization bridge (B21: NO), the computation core 72 terminates the processing of estimating the time synchronization master clock.

When determining that the first synchronization message is received from the time synchronization bridge (B21: YES), the computation core 72 stores the reception timestamp Ts3 of the first synchronization message in the RAM 74 (B22). The computation core 72 waits for receiving the second synchronization message from the time synchronization bridge (B23).

When determining that the second synchronization message is received from the time synchronization bridge (B23: YES), the computation core 72 extracts the transmission timestamp Tm3 of the first synchronization message, the propagation delay time D2, and the residence time R1 from the second synchronization message and stores them in the RAM 74 (B24).

The computation core 72 reads Ts3, Tm3, D2+R1, and D1 stored in the RAM 74, calculates the time difference C between the clock tm of the time synchronization master and the clock ts of the time synchronization slave 1 by arithmetic expression 3 (B25), and terminates the processing of computing the time difference of the time synchronization master clock.

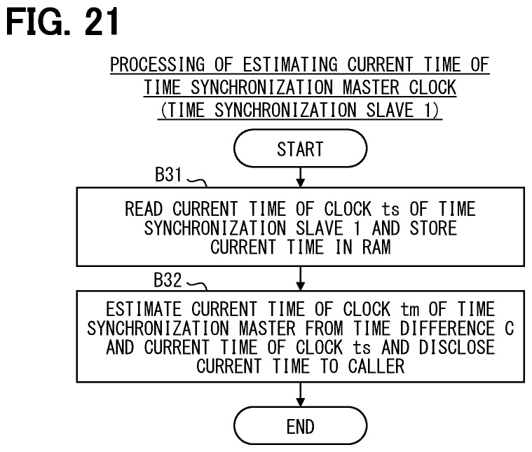

(1-17) Processing of Estimating Current Time of Time Synchronization Master Clock Performed by Time Synchronization Slave 1 (See FIG. 21)

In the time synchronization slave 1, the computation core 72 performs the processing of estimating the current time of the time synchronization master clock by calling the current time of the clock tm from an application used for control, for example. When the processing of estimating the current time of the time synchronization master clock is started, the computation core 72 reads the current time of the clock ts of the time synchronization slave 1 and stores the current time in the RAM 74 (B31). The computation core 72 estimates the clock tm of the time synchronization master by arithmetic expression 4 from the time difference C between the clock tm of the time synchronization master and the clock ts of the time synchronization slave 1 and the current time of the clock ts of the time synchronization slave 1, discloses the clock tm to the caller (B32), and terminates the processing of estimating the current time of the time synchronization master clock.

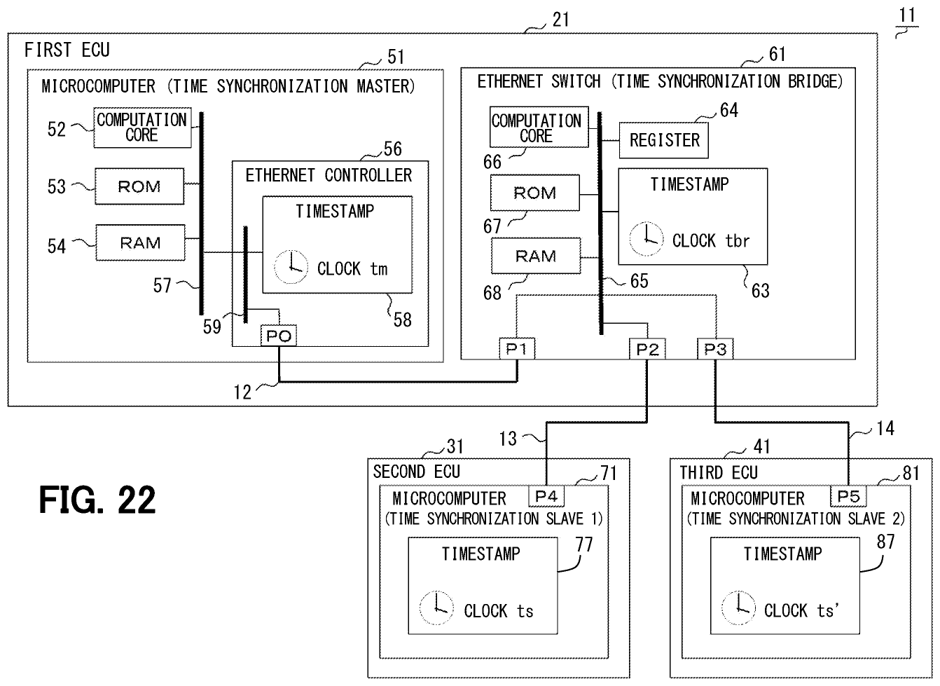

As a comparison target, as illustrated in FIG. 22, a configuration in which the general-purpose IO 55 is omitted in the microcomputer 51, and the general-purpose IO 62 is omitted and a computation core 66, a ROM 67, and a RAM 68 are provided in the Ethernet switch 61 as compared with the configuration illustrated in FIG. 1 will be described.

In the configuration of the comparison target illustrated in FIG. 22, it is necessary for the time synchronization bridge to have the computation core 66, the ROM 67, and the RAM 68. On the other hand, in the configuration illustrated in FIG. 1, it is not necessary for the time synchronization bridge to have the computation core 66, the ROM 67, and the RAM 68, and the time synchronization master is configured to remotely control the time synchronization bridge, and the transmission of the message from the time synchronization master is managed by the computation core 52 as described above, so that it is possible to avoid the occurrence of the trouble in the time management of messages in advance.

As described above, according to the first embodiment, the following operational effects can be obtained. In the time synchronization communication system 11, the time synchronization master is configured to remotely control the time synchronization bridge, and after the preceding message is transmitted to the time synchronization bridge, the subsequent message is transmitted to the time synchronization bridge on condition that the time synchronization master has acquired the reception timestamp held in the register 64 as the preceding message is received by the time synchronization bridge from the time synchronization bridge. By transmitting the subsequent message to the time synchronization bridge on condition that the time synchronization master has acquired the time held in the register 64 from the time synchronization bridge, it is possible to avoid the occurrence of the trouble in the time management of messages in advance. With the configuration in which the time synchronization master remotely controls the time synchronization bridge, it is possible to appropriately transmit and receive messages while solving the problem of the cost of development and manufacturing of software and hardware.

By using the down counter, it can be easily achieved by adding a software or hardware down counter. In addition, by appropriately changing the predetermined time measured by the down counter depending on the data communication speed, connection form, or the like between the time synchronization master and the time synchronization bridge, it is possible to flexibly cope with changes in system specifications and the like.

Although the configuration in which the Ethernet switch 61 is disposed separately from the microcomputer 51 in the first ECU 51 has been described above, the Ethernet switch 61 may be built in the microcomputer 51.

### Second Embodiment

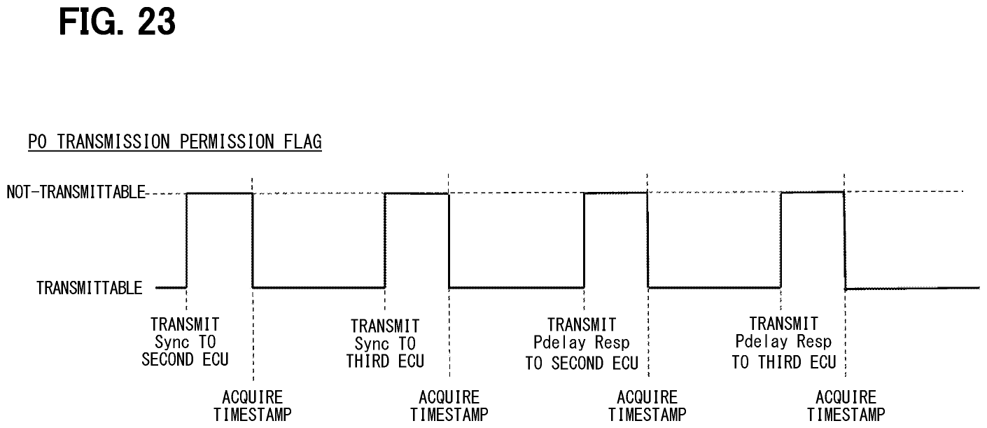

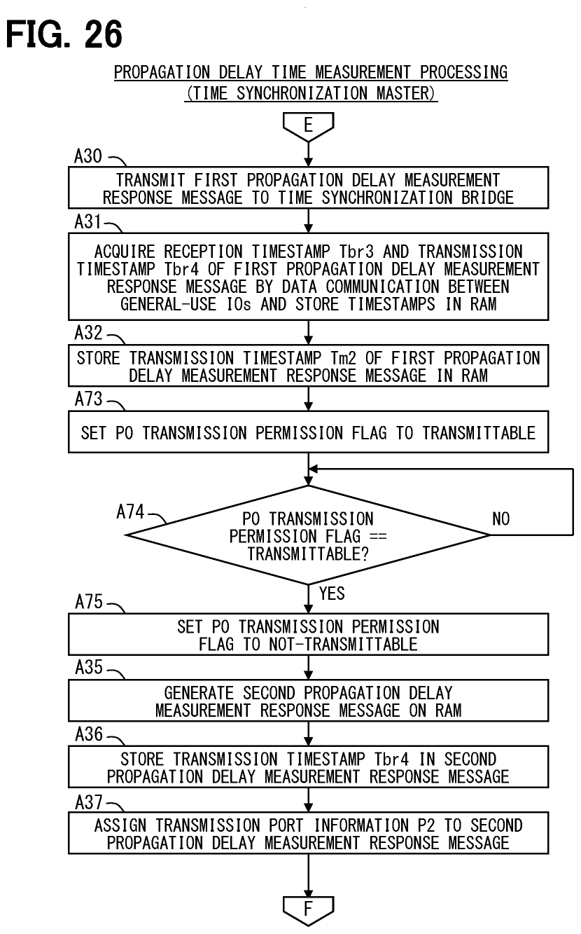

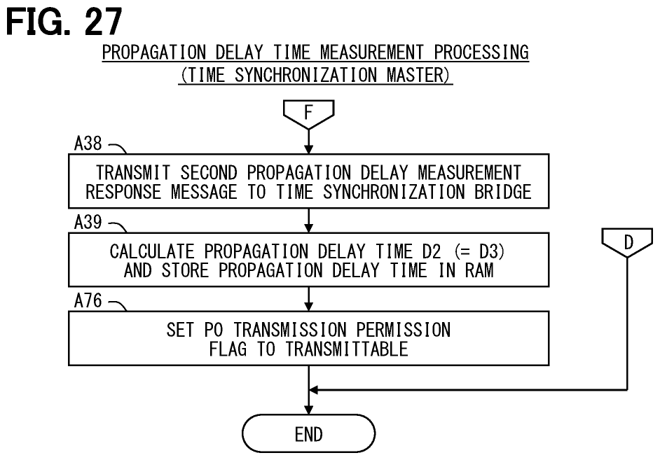

A second embodiment will be described with reference to FIGS. 23 to 29. In the first embodiment described above, the down counter is used as a method of controlling the transmission of a message from the communication port P0, but in the second embodiment, a transmission permission flag is used.

As illustrated in FIG. 23, the computation core 52 has a P0 transmission permission flag, can set the P0 transmission permission flag to transmittable or not-transmittable, prohibits the transmission of the message while the P0 transmission permission flag is set to not-transmittable, and permits the transmission of the message while the P0 transmission permission flag is set to transmittable. When the message transmission request event is established, the computation core 52 sets the P0 transmission permission flag to not-transmittable and transmits the message from the time synchronization master to the time synchronization bridge.

The computation core 52 waits for the establishment of a new message transmission request event after setting the P0 transmission permission flag to not-transmittable, but does not transmit the new message from the time synchronization master to the time synchronization bridge as long as the setting of not-transmittable is continued even if the new message transmission request event is established. The computation core 52 monitors whether or not the reception timestamp held in the register 64 is acquired, and when the reception timestamp held in the register 64 is acquired, sets the P0 transmission permission flag to transmittable. When a new message transmission request event is established, the computation core 52 sets the P0 transmission permission flag to not-transmittable again and transmits the new message from the time synchronization master to the time synchronization bridge. The computation core 52 repeats the processing.

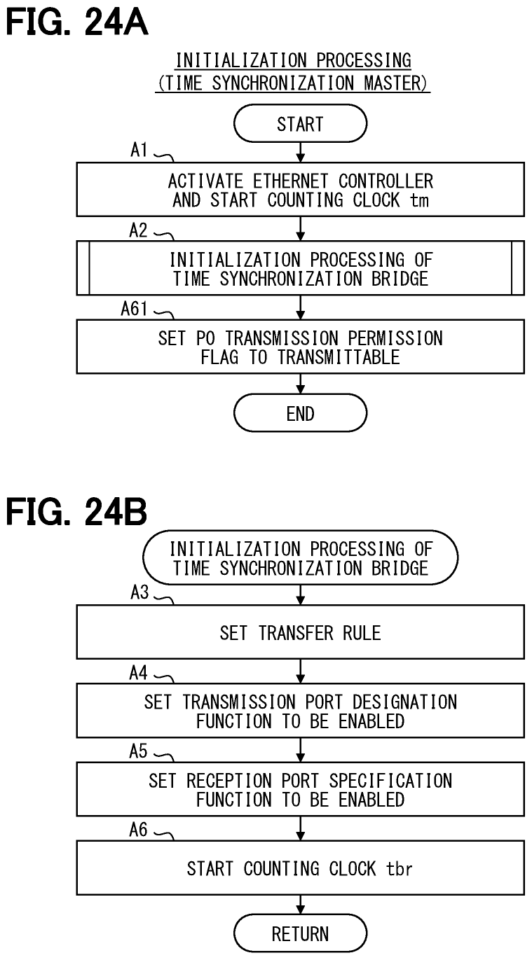

Next, the operation of the above configuration will be described with reference to FIGS. 24A to 29. Here, the initialization processing performed by the time synchronization master, the initialization processing performed by the time synchronization slave 1, the propagation delay time measurement processing performed by the time synchronization slave 1, the propagation delay time measurement processing performed by the time synchronization master, the reference time distribution processing performed by the time synchronization master, the processing of computing the time difference of the time synchronization master clock performed by the time synchronization slave 1, and the processing of estimating the current time of the time synchronization master clock performed by the time synchronization slave 1 will be sequentially described. Since the down counter is not used in the second embodiment, the down-count processing performed by the time synchronization master described in the first embodiment is not performed.

(2-11) Initialization Processing Performed by Time Synchronization Master (see FIGS. 24A and 24B)

In the time synchronization master, when the initialization processing is started, the computation core 52 performs steps A1 to A6, sets the P0 transmission permission flag to transmittable (A61), and terminates the initialization processing.

(2-12) Initialization Processing Performed by Time Synchronization Slave 1

In the time synchronization slave 1, the computation core 72 performs processing similar to the initialization processing performed by the time synchronization slave 1 described in the first embodiment.

(2-13) Propagation Delay Time Measurement Processing Performed by Time Synchronization Slave 1

In the time synchronization slave 1, the computation core 72 performs processing similar to the propagation delay time measurement processing performed by the time synchronization slave 1 described in the first embodiment.

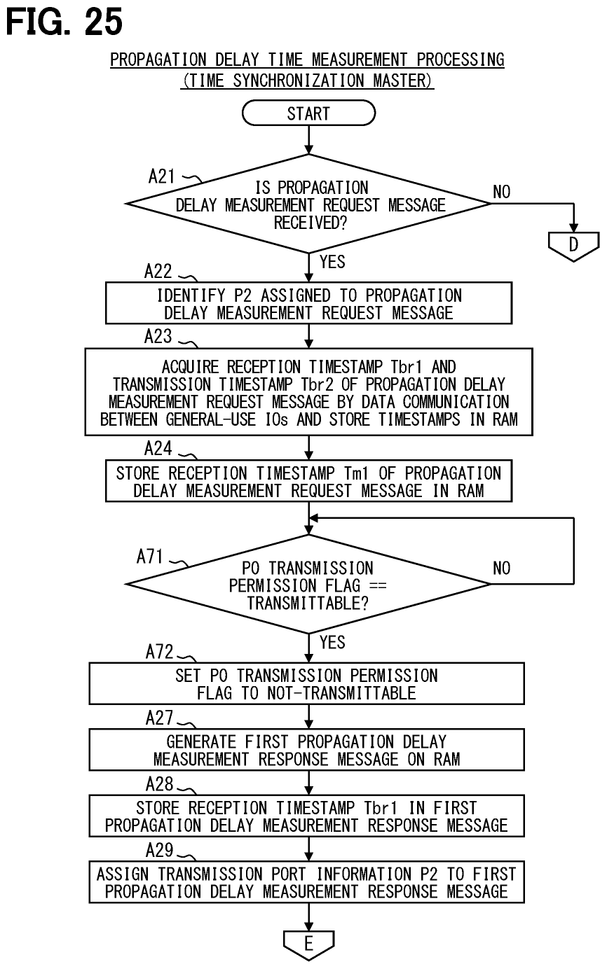

(2-14) Propagation Delay Time Measurement Processing Performed by Time Synchronization Master (see FIGS. 25 to 27)

When the propagation delay time measurement processing is started, the computation core 52 performs steps A21 to A24 and determines whether or not the P0 transmission permission flag is set to transmittable (A71). When determining that the P0 transmission permission flag is not set to transmittable (A71: NO), the computation core 52 stands by until the P0 transmission permission flag is set to transmittable. When determining that the P0 transmission permission flag is set to transmittable (A71: YES), the computation core 52 sets the P0 transmission permission flag to not-transmittable (A72).

The computation core 52 performs steps A27 to A32, sets the P0 transmission permission flag to transmittable (A73), and determines whether or not the P0 transmission permission flag is set to transmittable (A74). When determining that the P0 transmission permission flag is not set to transmittable (A74: NO), the computation core 52 stands by until the P0 transmission permission flag is set to transmittable. When determining that the P0 transmission permission flag is set to transmittable (A74: YES), the computation core 52 sets the P0 transmission permission flag to not-transmittable (A75). The computation core 52 performs steps A35 to A39, sets the P0 transmission permission flag to transmittable (A76), and terminates the propagation delay time measurement processing.

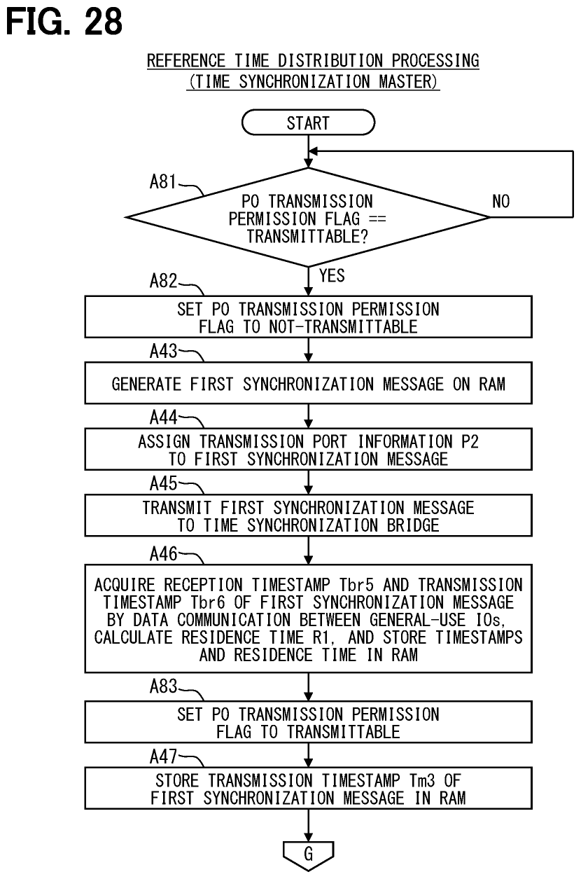

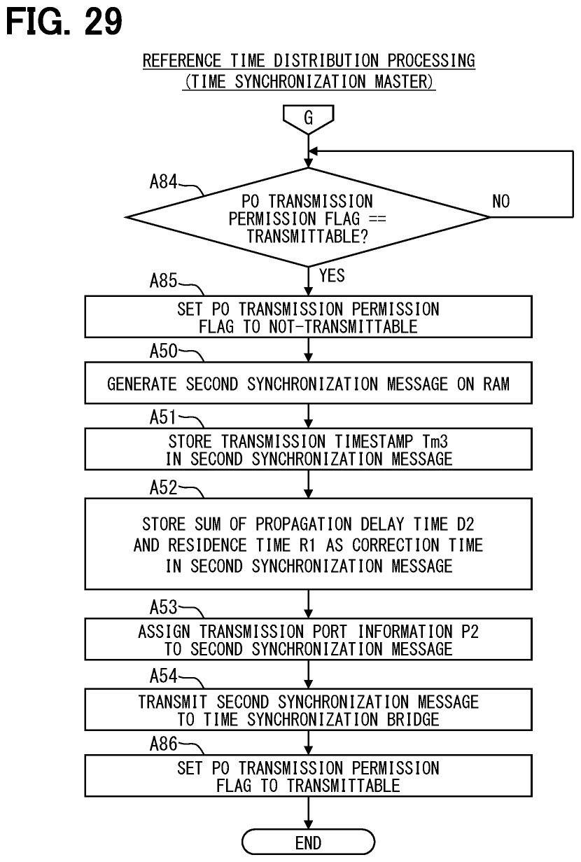

(2-15) Reference Time Distribution Processing Performed by Time Synchronization Master (See FIGS. 28 to 29)

In the time synchronization master, the computation core 52 performs the reference time distribution processing every transmission cycle (for example, 125 milliseconds) of the first synchronization message determined in advance. When the reference time distribution processing is started, the computation core 52 determines whether or not the P0 transmission permission flag is set to transmittable (A81). When determining that the P0 transmission permission flag is not set to transmittable (A81: NO), the computation core 52 stands by until the P0 transmission permission flag is set to transmittable. When determining that the P0 transmission permission flag is set to transmittable (A81: YES), the computation core 52 sets the P0 transmission permission flag to not-transmittable (A82).

The computation core 52 performs steps A43 to A46 and sets the P0 transmission permission flag to transmittable (A83). The computation core 52 performs step A47 and determines whether or not the P0 transmission permission flag is set to transmittable (A84). When determining that the P0 transmission permission flag is not set to transmittable (A84: NO), the computation core 52 stands by until the P0 transmission permission flag is set to transmittable. When determining that the P0 transmission permission flag is set to transmittable (A84: YES), the computation core 52 sets the P0 transmission permission flag to not-transmittable (A85). The computation core 52 performs steps A50 to A54, sets the P0 transmission permission flag to transmittable (A86), and terminates the reference time distribution processing.

(2-16) Processing of Computing Time Difference of Time Synchronization Master Clock Performed by Time Synchronization Slave 1

In the time synchronization slave 1, the computation core 72 performs processing similar to the processing of computing the time difference of the time synchronization master clock described in the first embodiment.

(2-17) Processing of Estimating Current Time of Time Synchronization Master Clock Performed by Time Synchronization Slave 1

In the time synchronization slave 1, the computation core 72 performs processing similar to the processing of estimating the current time of the time synchronization master clock described in the first embodiment.

As described above, according to the second embodiment, the following operational effects can be obtained. As in the first embodiment, after the preceding message is transmitted to the time synchronization bridge, the subsequent message is transmitted to the time synchronization bridge on condition that the time synchronization master has acquired the reception timestamp held in the register 64 as the preceding message is received by the time synchronization bridge from the time synchronization bridge. By transmitting the second message to the time synchronization bridge on condition that the time synchronization master has acquired the time held in the register 64 from the time synchronization bridge, it is possible to avoid the occurrence of the trouble in the time management of messages in advance.

By using the transmission permission flag, it can be easily achieved without adding a software or hardware down counter.

### Third Embodiment

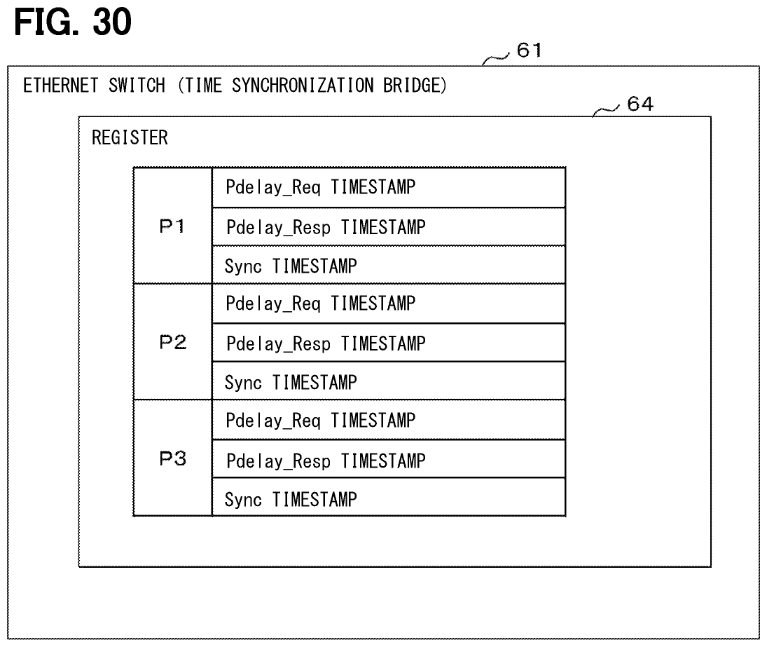

A third embodiment will be described with reference to FIGS. 30 to 37. In the first embodiment described above, one down counter is used for a plurality of messages, but in the third embodiment, individual down counters are used for a plurality of messages.

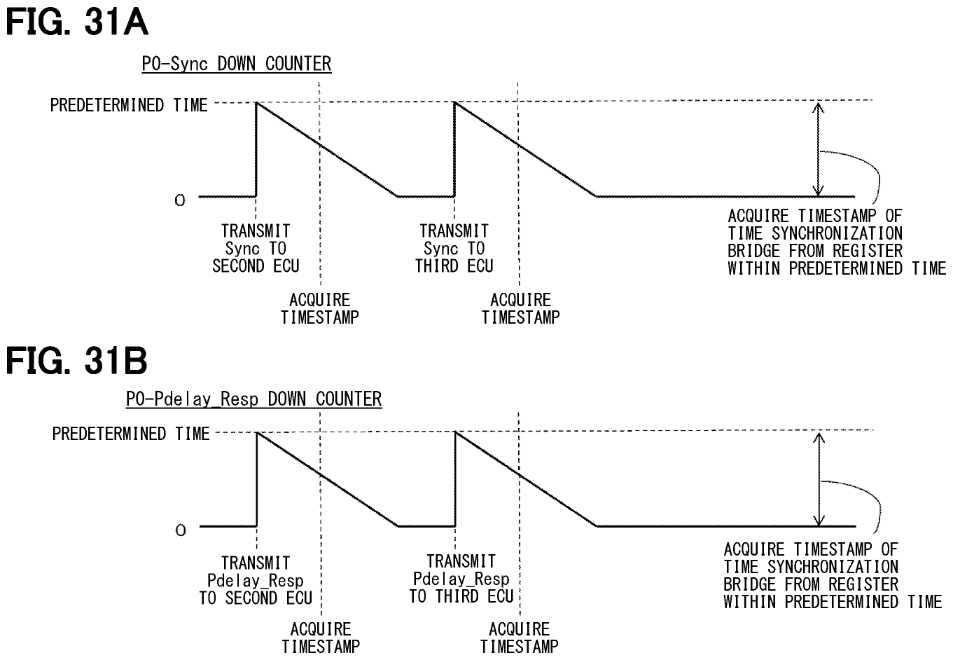

As illustrated in FIG. 30, the register 64 has a propagation-delay-measurement request message timestamp holding area, a propagation-delay-measurement response message timestamp holding area, and a synchronization message timestamp holding area for each of the communication ports P1, P2, and P3. As illustrated in FIG. 31, the computation core 52 includes a P0-Sync down counter that controls the transmission of a synchronization message and a P0-Pdelay_Resp down counter that controls the transmission of a propagation delay measurement response message. The P0-Sync down counter supports the first synchronization message. The P0-Pdelay_Resp down counter supports the first propagation delay measurement response message. Each of the P0-Sync down counter and the P0-Pdelay_Resp down counter has a function similar to that of the P0 down counter described in the first embodiment.

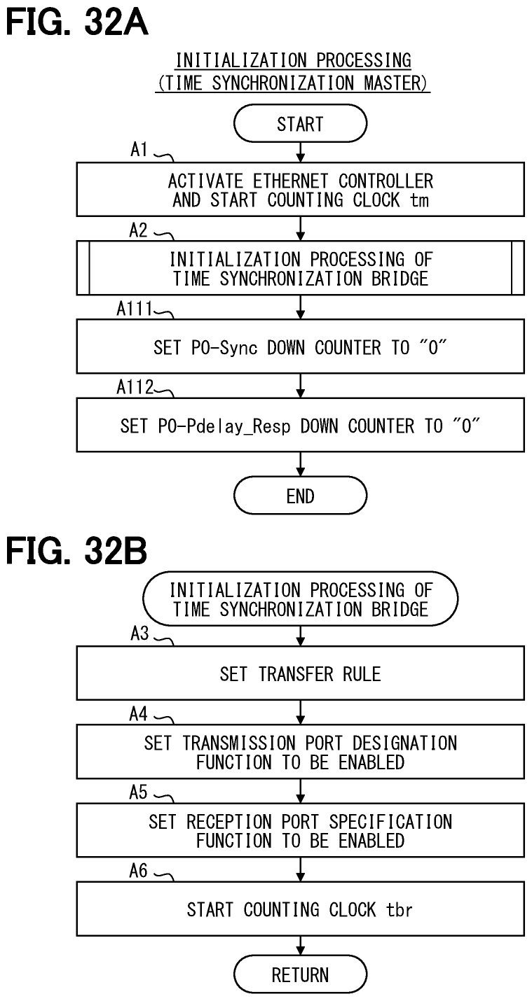

Next, the operation of the above configuration will be described with reference to FIGS. 32A to 37. Here, the initialization processing performed by the time synchronization master, the initialization processing performed by the time synchronization slave 1, the down-count processing performed by the time synchronization master, the propagation delay time measurement processing performed by the time synchronization slave 1, the propagation delay time measurement processing performed by the time synchronization master, the reference time distribution processing performed by the time synchronization master, and the time synchronization master clock estimation processing performed by the time synchronization slave 1 will be sequentially described.

(3-11) Initialization Processing Performed by Time Synchronization Master (see FIGS. 32A and 32B)

In the time synchronization master, when the initialization processing is started, the computation core 52 performs steps A1 to A6, sets the P0-Sync down counter to “0” (A111), sets the P0-Pdelay_Resp down counter to “0” (A112), and terminates the initialization processing.

(3-12) Initialization Processing Performed by Time Synchronization Slave 1

In the time synchronization slave 1, the computation core 72 performs processing similar to the initialization processing performed by the time synchronization slave 1 described in the first embodiment.

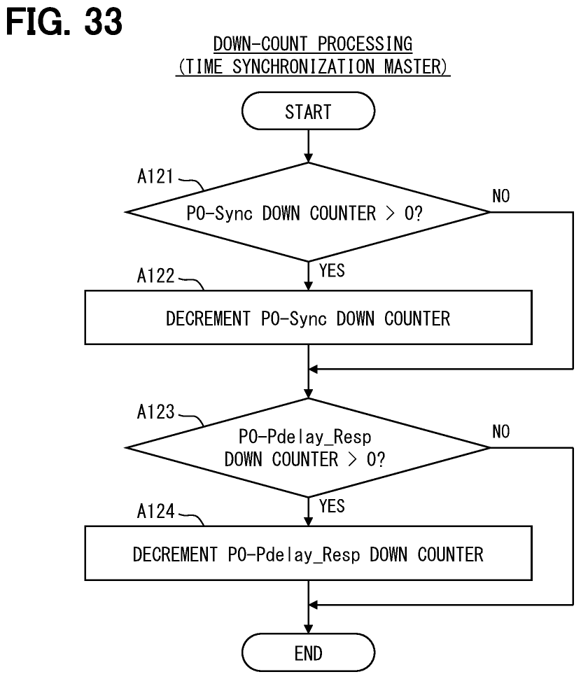

(3-13) Down-Count Processing Performed by Time Synchronization Master (see FIG. 33)

In the time synchronization master, the computation core 52 performs down-count processing every predetermined cycle (for example, one millisecond) determined in advance. When the down-count processing is started, the computation core 52 determines whether or not the count value of the P0-Sync down counter exceeds “0” (A121). When determining that the count value of the P0-Sync down counter does not exceed “0” (A121: NO), that is, when determining that the counting of the P0-Sync down counter is being stopped, the computation core 52 performs step A123.

When determining that the count value of the P0-Sync down counter exceeds “0” (A121: YES), that is, when determining that the counting of the P0-Sync down counter is being performed, the computation core 52 decrements the count value of the P0-Sync down count (A122), and performs step A123.

The computation core 52 determines whether or not the count value of the P0-Pdelay_Resp down counter exceeds “0” (A123). When determining that the count value of the P0-Pdelay_Resp down counter does not exceed “0” (A123: NO), that is, when determining that the counting of the P0-Pdelay_Resp down counter is being stopped, the computation core 52 terminates the down-count processing.

When determining that the count value of the P0-Pdelay_Resp down counter exceeds “0” (A123: YES), that is, when determining that the counting of the P0-Pdelay_Resp down counter is being performed, the computation core 52 decrements the count value of the P0-Pdelay_Resp down counter (A124), and terminates the down-count processing.

(3-14) Propagation Delay Time Measurement Processing Performed by Time Synchronization Slave 1

In the time synchronization slave 1, the computation core 72 performs processing similar to the propagation delay time measurement processing performed by the time synchronization slave 1 described in the first embodiment.

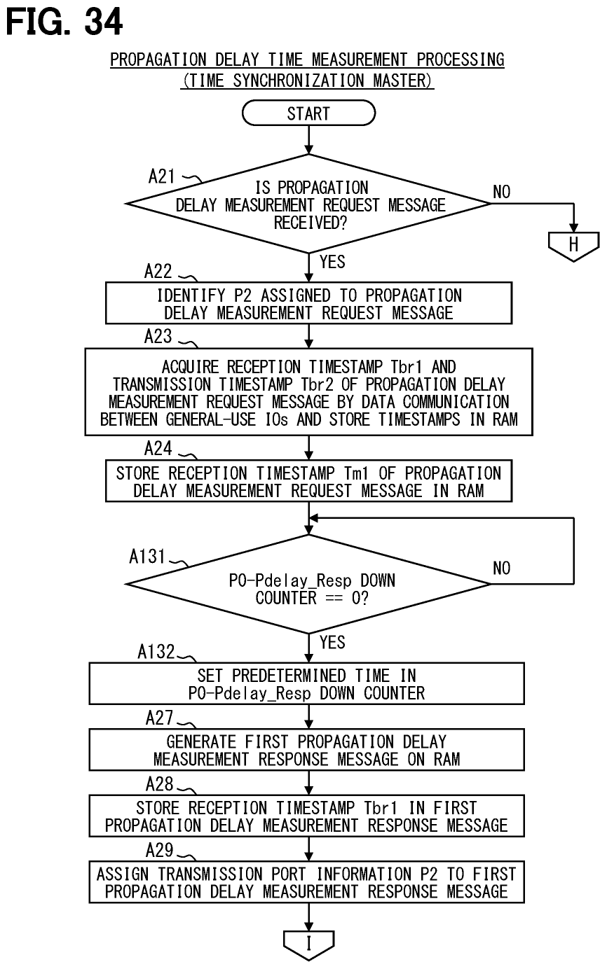

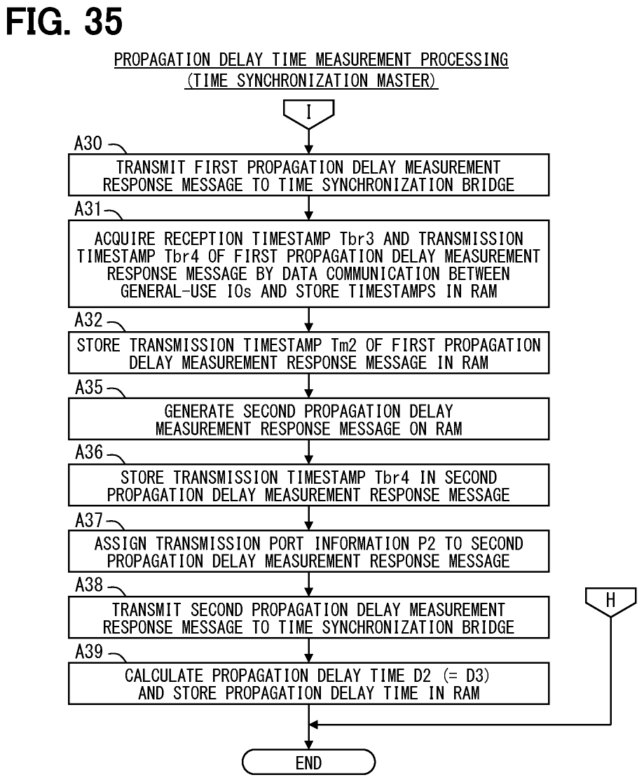

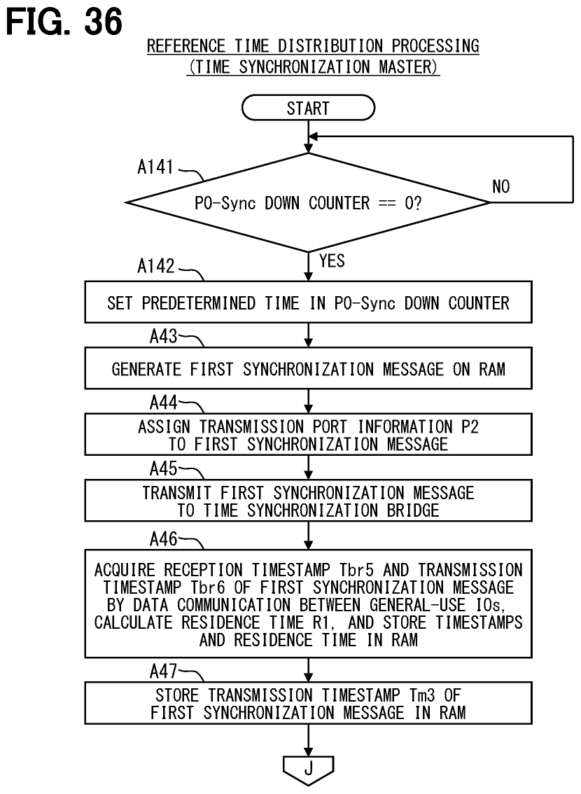

(3-15) Propagation Delay Time Measurement Processing Performed by Time Synchronization Master (See FIGS. 34 to 35)

When the propagation delay time measurement processing is started, the computation core 52 performs steps A21 to A24 and determines whether or not the count value of the P0-Pdelay_Resp down counter is “0” (A131). When determining that the count value of the P0-Pdelay_Resp down counter is not “0” (A131: NO), the computation core 52 stands by until the count value of the P0-Pdelay_Resp reaches “0”. When determining that the count value of the P0-Pdelay_Resp is “0” (A131: YES), the computation core 52 sets the count value of the P0-Pdelay_Resp down counter to a predetermined time (A132). The computation core 52 performs steps A27 to A32 and steps A35 to A39, and terminates the propagation delay time measurement processing.

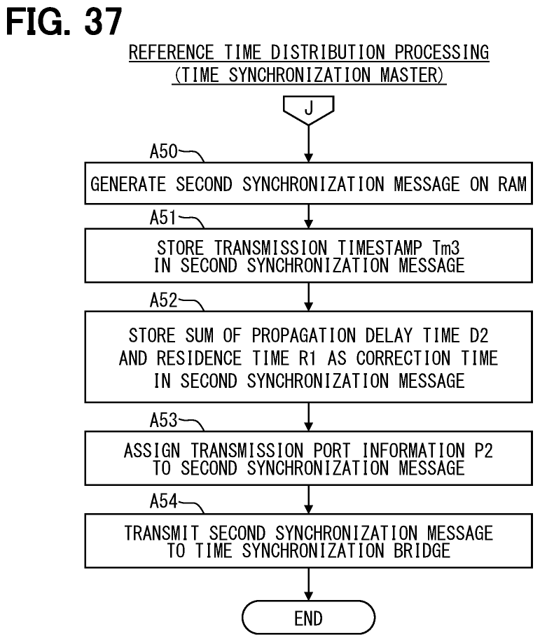

(3-16) Reference Time Distribution Processing Performed by Time Synchronization Master (See FIGS. 36 to 37)

In the time synchronization master, the computation core 52 performs the reference time distribution processing every transmission cycle (for example, 125 milliseconds) of the first synchronization message determined in advance. When the reference time distribution processing is started, the computation core 52 determines whether or not the count value of the P0-Sync down counter is “0” (A141). When determining that the count value of the P0-Sync down counter is not “0” (A141: NO), the computation core 52 stands by until the count value of the P0-Sync down counter reaches “0”. When determining that the count value of the P0-Sync down counter is “0” (A141: YES), the computation core 52 sets the count value of the P0-Sync down counter to a predetermined time (A142). The computation core 52 performs steps A43 to A47 and steps A50 to A54, and terminates the reference time distribution processing.

(3-17) Time Synchronization Master Clock Estimation Processing Performed by Time Synchronization Slave 1

In the time synchronization slave 1, the computation core 72 performs processing similar to the time synchronization master clock estimation processing described in the first embodiment.

As described above, according to the third embodiment, the following operational effects can be obtained. As in the first embodiment, after the preceding message is transmitted to the time synchronization bridge, the subsequent message is transmitted to the time synchronization bridge on condition that the time synchronization master has acquired the reception timestamp held in the register 64 as the preceding message is received by the time synchronization bridge from the time synchronization bridge. It is possible to prevent the reception timestamp of the first synchronization message addressed to the time synchronization slave 1 from being overwritten with the reception timestamp of the first synchronization message addressed to the time synchronization slave 2.

### Fourth Embodiment

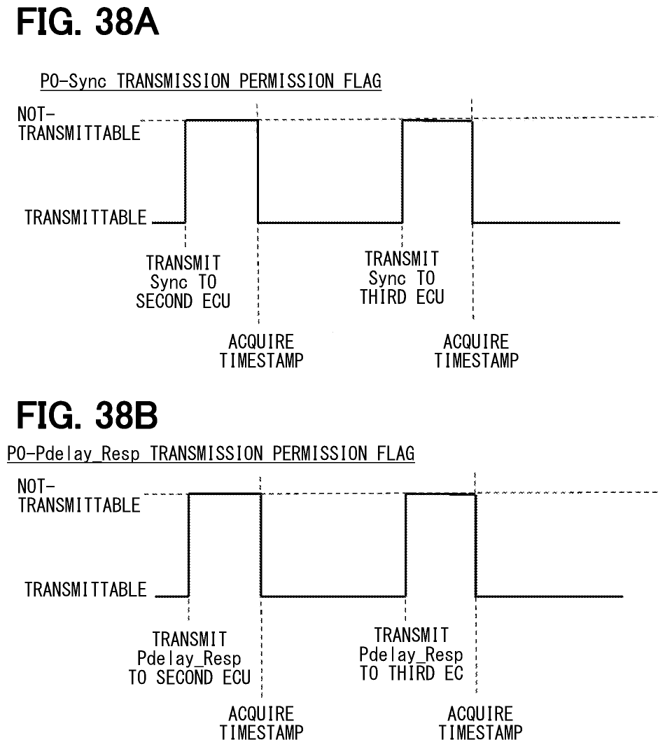

A fourth embodiment will be described with reference to FIGS. 38A to 43. In the second embodiment described above, one transmission permission flag is used for a plurality of messages, but in the fourth embodiment, individual transmission permission flags are used for a plurality of messages.

As illustrated in FIGS. 38A and 38B, the computation core 52 includes a P0-Sync transmission permission flag that controls the transmission of a synchronization message and a P0-Pdelay_Resp transmission permission flag that controls the transmission of a propagation delay measurement response message. Each of the P0-Sync transmission permission flag and the P0-Pdelay_Resp transmission permission flag has a function similar to that of the P0 transmission permission flag described in the second embodiment.

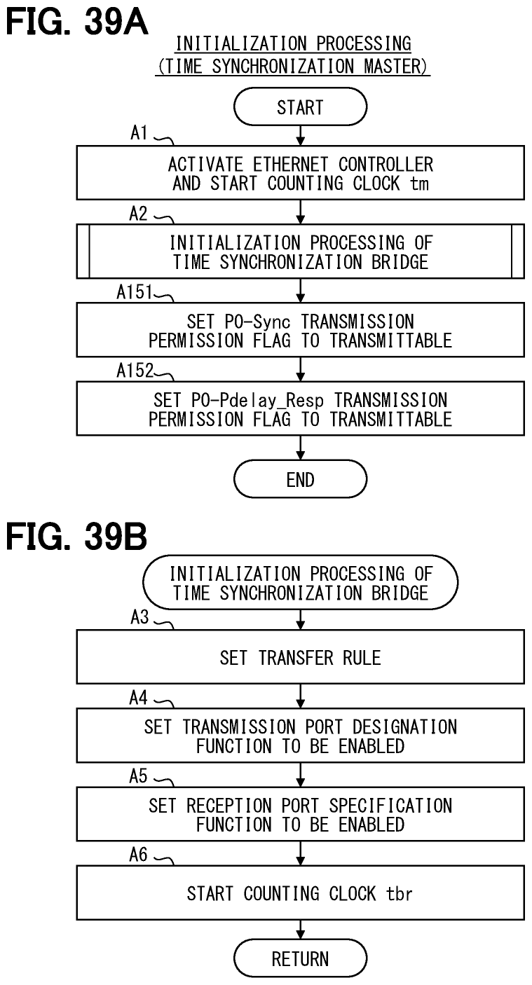

Next, the operation of the above configuration will be described with reference to FIGS. 39A to 43. Here, the initialization processing performed by the time synchronization master, the initialization processing performed by the time synchronization slave 1, the propagation delay time measurement processing performed by the time synchronization slave 1, the propagation delay time measurement processing performed by the time synchronization master, the reference time distribution processing performed by the time synchronization master, and the time synchronization master clock estimation processing performed by the time synchronization slave 1 will be sequentially described.

(4-11) Initialization Processing Performed by Time Synchronization Master (see FIGS. 39A and 39B)

In the time synchronization master, when the initialization processing is started, the computation core 52 performs steps A1 to A6, sets the P0-Sync transmission permission flag to transmittable (A151), sets the P0-Pdelay_Resp transmission permission flag to transmittable (A152), and terminates the initialization processing.

(4-12) Initialization Processing Performed by Time Synchronization Slave 1

In the time synchronization slave 1, the computation core 72 performs processing similar to the initialization processing performed by the time synchronization slave 1 described in the first embodiment.

(4-13) Propagation Delay Time Measurement Processing Performed by Time Synchronization Slave 1

In the time synchronization slave 1, the computation core 72 performs processing similar to the propagation delay time measurement processing performed by the time synchronization slave 1 described in the first embodiment.

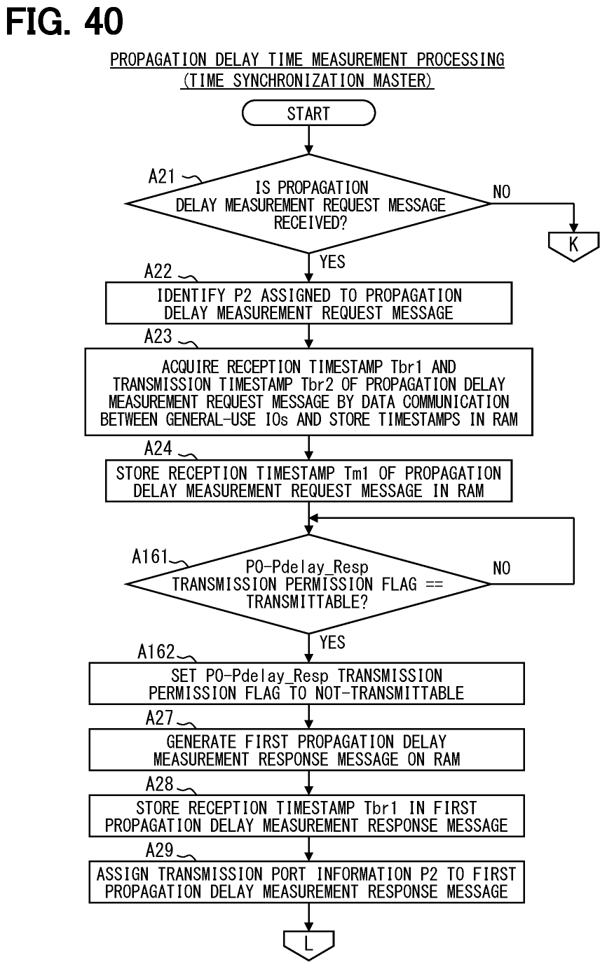

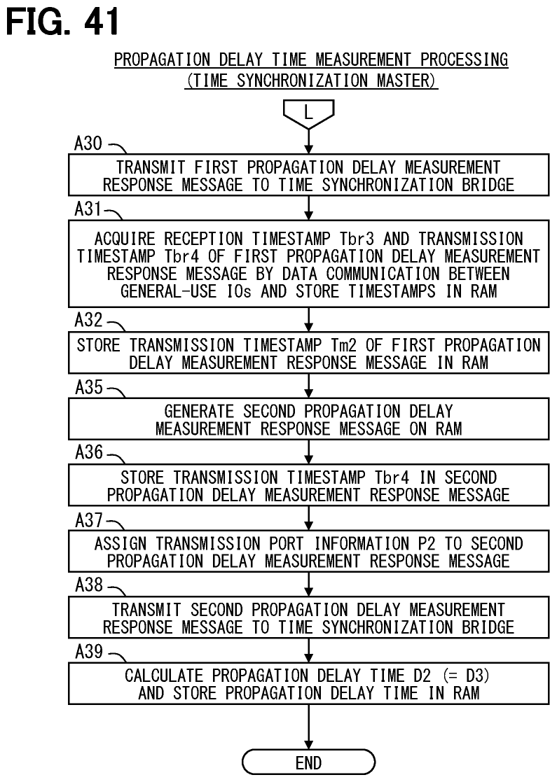

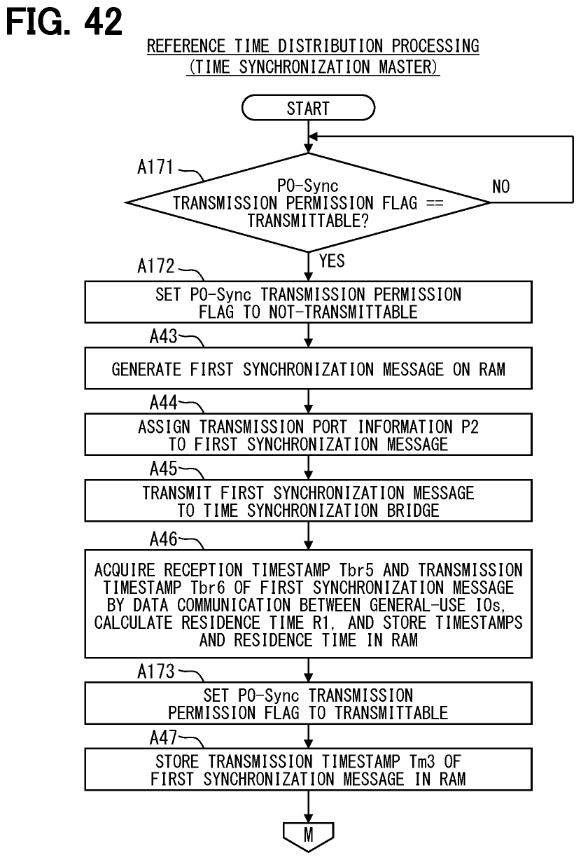

(4-14) Propagation Delay Time Measurement Processing Performed by Time Synchronization Master (See FIGS. 40 to 41)

When the propagation delay time measurement processing is started, the computation core 52 performs steps A21 to A24 and determines whether or not the P0-Pdelay_Resp transmission permission flag is set to transmittable (A161). When determining that the P0-Pdelay_Resp transmission permission flag is not set to transmittable (A161: NO), the computation core 52 stands by until the P0-Pdelay_Resp transmission permission flag is set to transmittable. When determining that the P0-Pdelay_Resp transmission permission flag is set to transmittable (A161: YES), the computation core 52 sets the P0-Pdelay_Resp transmission permission flag to not-transmittable (A162).

The computation core 52 performs steps A27 to A32 and steps A35 to A39, and terminates the propagation delay time measurement processing.

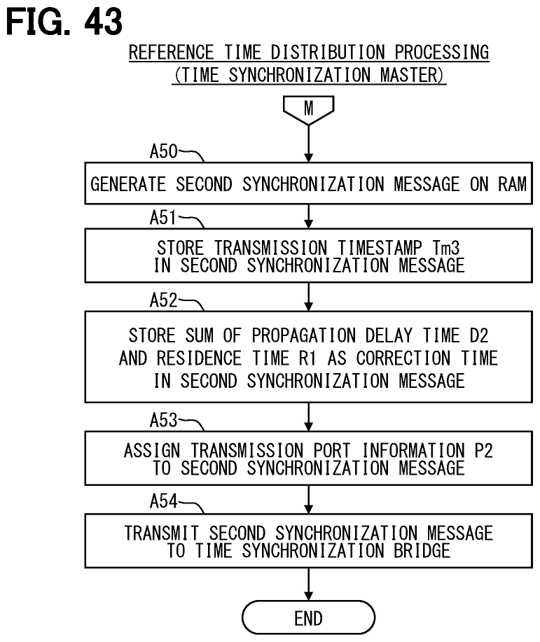

(4-15) Reference Time Distribution Processing Performed by Time Synchronization Master (See FIGS. 42 to 43)

In the time synchronization master, the computation core 52 performs the reference time distribution processing every transmission cycle (for example, 125 milliseconds) of the first synchronization message determined in advance. When the reference time distribution processing is started, the computation core 52 determines whether or not the P0-Sync transmission permission flag is set to transmittable (A171). When determining that the P0-Sync transmission permission flag is not set to transmittable (A171: NO), the computation core 52 stands by until the P0-Sync transmission permission flag is set to transmittable. When determining that the P0-Sync transmission permission flag is set to transmittable (A171: YES), the computation core 52 sets the P0-Sync transmission permission flag to not-transmittable (A172). The computation core 52 performs steps A43 to A46, sets the P0-Sync transmission permission flag to transmittable (A173), performs step A47 and steps A50 to A54, and terminates the reference time distribution processing.

(4-16) Time Synchronization Master Clock Estimation Processing Performed by Time Synchronization Slave 1

In the time synchronization slave 1, the computation core 72 performs processing similar to the time synchronization master clock estimation processing described in the first embodiment.

As described above, according to the fourth embodiment, the following operational effects can be obtained. As in the first embodiment, after the preceding message is transmitted to the time synchronization bridge, the subsequent message is transmitted to the time synchronization bridge on condition that the time synchronization master has acquired the reception timestamp held in the register 64 as the preceding message is received by the time synchronization bridge from the time synchronization bridge. It is possible to prevent the reception timestamp of the first synchronization message addressed to the time synchronization slave 1 from being overwritten with the reception timestamp of the first synchronization message addressed to the time synchronization slave 2.

### Fifth Embodiment

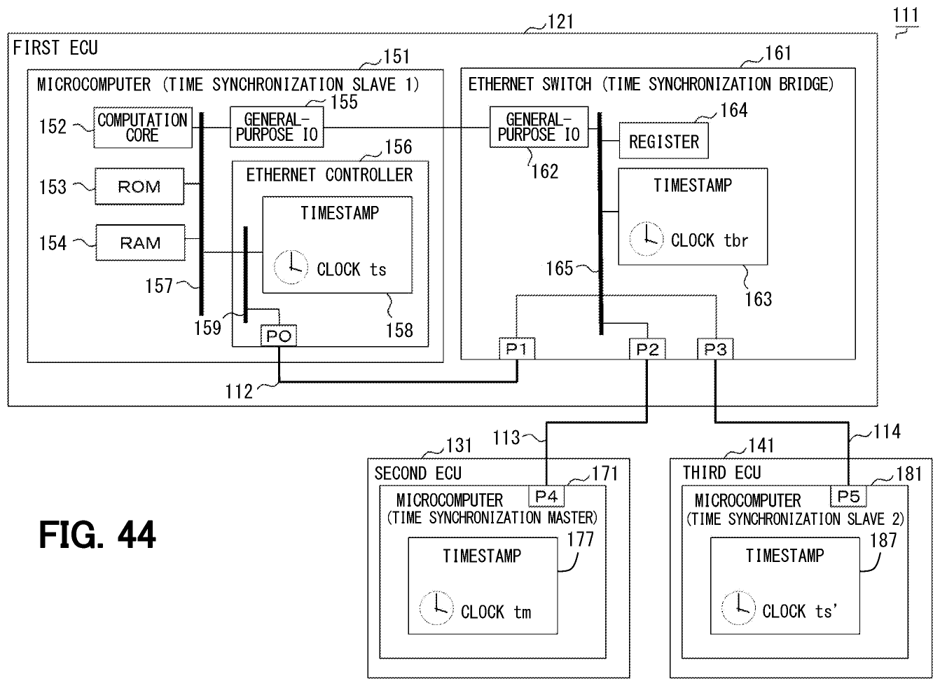

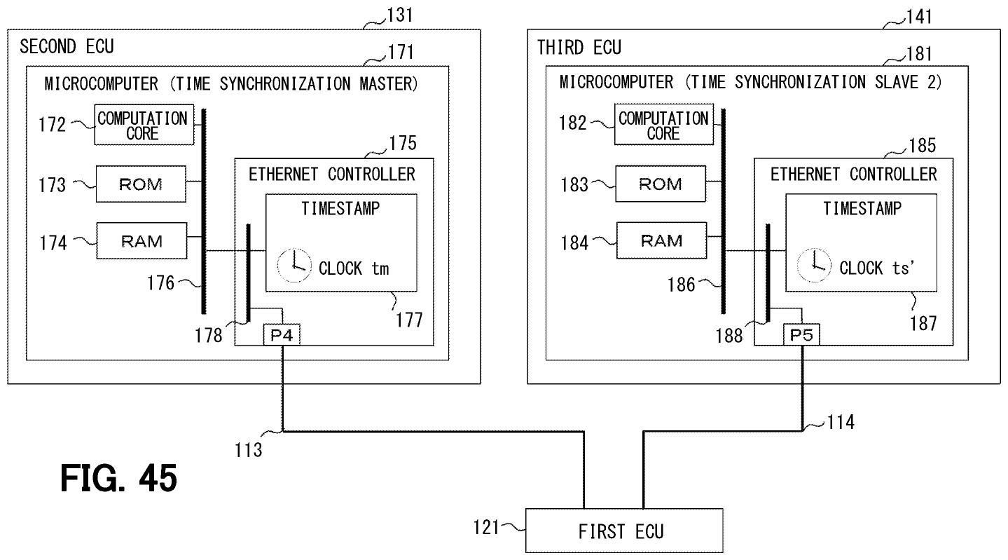

Next, a fifth embodiment will be described with reference to FIGS. 44 to 45. In the first embodiment described above, the time synchronization master remotely controls the time synchronization bridge, but in the fifth embodiment, the time synchronization slave remotely controls the time synchronization bridge.

As illustrated in FIG. 44, a time synchronization communication system 111 includes a first ECU 121, a second ECU 131, and a third ECU 141 as data communication systems for a vehicle. The time synchronization communication system 111 performs data communication to which a time synchronization protocol based on IEEE 802.1 AS (gPTP) is applied, among the first ECU 121, the second ECU 131, and the third ECU 141.

The first ECU 121 includes a microcomputer 151 and an Ethernet switch 161. The microcomputer 151 is a node that synchronizes with the reference time distributed from the time synchronization master in the time synchronization communication system 111, and functions as a time synchronization slave 1. The Ethernet switch 161 is a node that relays a message in the time synchronization communication system 111, and functions as a time synchronization bridge. The microcomputer 151 corresponds to a time synchronization end station.

The microcomputer 151 is configured by interconnecting a computation core 152 (corresponding to “transmission control section”), a ROM 153, a RAM 154, a general-purpose IO 155, and an Ethernet controller 156 via a bus 157. The computation core 152 controls the overall operation of the first ECU 121 by performing computation processing. By executing a propagation delay time calculation program, the computation core 152 calculates the propagation delay time between the time synchronization slave 1 and the time synchronization bridge, which will be described later. The ROM 153 is a storage area for storing various data. The RAM 154 is a storage area that functions as a work area when the computation core 152 performs the computation processing. The general-purpose IO 155 performs data communication conforming to a general-purpose communication protocol such as SPI with a general-purpose IO to be described later of the Ethernet switch 161.

The Ethernet controller 156 is configured by interconnecting a timestamp section 158 (corresponding to “first time recording section”) and the communication port P0 via a bus 159. The timestamp section 158 includes a timer that measures the clock ts, and records the time measured by the timer. The computation core 152 accesses the timestamp section 158 via the buses 157 and 159, reads the time recorded by the timestamp section 158, and stores the read time in the RAM 154. The communication port P0 is connected to the communication port P1, which will be described later, of the Ethernet switch 161 via Ethernet 112. The communication port P0 performs data communication conforming to the Ethernet communication protocol with the communication port P1.

The Ethernet switch 161 has a configuration similar to the Ethernet switch 61 described in the first embodiment, and is configured by interconnecting a general-purpose IO 162, a timestamp section 163 (corresponding to “second time recording section”), a register 164 (corresponding to “time holding section”), and the communication ports P1, P2, and P3 via a bus 165. The general-purpose IO 162 performs data communication conforming to a general-purpose communication protocol such as SPI with the general-purpose IO 155 of the microcomputer 151. The timestamp section 163 includes a timer that measures the clock tbr, and records the time measured by the timer. The register 164 holds the timestamp recorded by the timestamp section 163.

The communication port P1 performs data communication conforming to the Ethernet communication protocol with the communication port P0 of the microcomputer 151. The communication port P2 is connected to the communication port P4, which will be described later, of the second ECU 131 via the Ethernet 113. The communication port P2 performs data communication conforming to the Ethernet communication protocol with the communication port P4. The communication port P3 is connected to the communication port P5, which will be described later, of the third ECU 141 via the Ethernet 114. The communication port P3 performs data communication conforming to the Ethernet communication protocol with the communication port P5.

The Ethernet switch 161 does not have a computation core and operates under the control of the computation core 152 of the microcomputer 151. That is, the microcomputer 151 functioning as a time synchronization slave 1 writes and reads data to and from the register 164 by the data communication between the general-purpose IOs 155 and 162, and remotely controls the Ethernet switch 161 functioning as a time synchronization bridge.

As illustrated in FIG. 45, the second ECU 131 includes a microcomputer 171. The microcomputer 171 is a node that distributes a reference time in the time synchronization communication system 111, and functions as a time synchronization master. The microcomputer 171 is configured by interconnecting a computation core 172, a ROM 173, a RAM 174, and an Ethernet controller 175 via a bus 176. The computation core 172 controls the overall operation of the second ECU 131 by performing computation processing. The ROM 173 is a storage area for storing various data. The RAM 174 is a storage area that functions as a work area when the computation core 172 performs the computation processing.

The Ethernet controller 175 is configured by interconnecting a timestamp section 177 and the communication port P4 via a bus 178. The timestamp section 177 includes a timer that measures the clock tm, and records the time measured by the timer. The computation core 172 accesses the timestamp section 177 via the buses 176 and 178, reads the time recorded by the timestamp section 177, and stores the read time in the RAM 174. The communication port P4 performs data communication conforming to the Ethernet communication protocol with the communication port P2 of the Ethernet switch 161.

The third ECU 141 has a configuration similar to the third ECU 41 described in the first embodiment, and includes a microcomputer 181. The microcomputer 181 is a node that synchronizes with the reference time distributed from the time synchronization master in the time synchronization communication system 11, and functions as a time synchronization slave 2. The microcomputer 181 is configured by interconnecting a computation core 182, a ROM 183, a RAM 184, and an Ethernet controller 185 via a bus 186. The computation core 182 controls the overall operation of the third ECU 141 by performing computation processing. The ROM 183 is a storage area for storing various data. The RAM 184 is a storage area that functions as a work area when the computation core 182 performs the computation processing.

The Ethernet controller 185 is configured by interconnecting a timestamp section 187 and the communication port P5 via a bus 188. The timestamp section 187 includes a timer that measures a clock ts′, and records the time measured by the timer. The computation core 182 accesses the timestamp section 187 via the buses 186 and 188, reads the time recorded by the timestamp section 187, and stores the read time in the RAM 184. The communication port P5 performs data communication conforming to the Ethernet communication protocol with the communication port P3 of the Ethernet switch 161.

In the configuration in which the time synchronization master remotely controls the time synchronization bridge, the transmission control is executed using the down counter and the transmission permission flag in a case where the time synchronization master transmits the propagation delay measurement response message and the synchronization message. On the other hand, in the configuration in which the time synchronization slave remotely controls the time synchronization bridge, the transmission control is executed using the down counter and the transmission permission flag in a case where the time synchronization slave transmits the time synchronization message. In this case, for example, the delay measurement request message transmitted from the time synchronization slave corresponds to the first message and the second message.

As described above, according to the fifth embodiment, the following operational effects can be obtained. Even in the configuration in which the time synchronization slave remotely controls the time synchronization bridge in the time synchronization communication system 111, the time synchronization slave acquires the timestamp of the preceding message held in the register 164 from the time synchronization bridge before the timestamp of the subsequent message is held in the register 164, so that it is possible to avoid the occurrence of the trouble in the time management of messages in advance.

Although the configuration in which the Ethernet switch 161 is disposed separately from the microcomputer 151 in the first ECU 151 has been described above, the Ethernet switch 161 may be built in the microcomputer 151.

### Sixth Embodiment

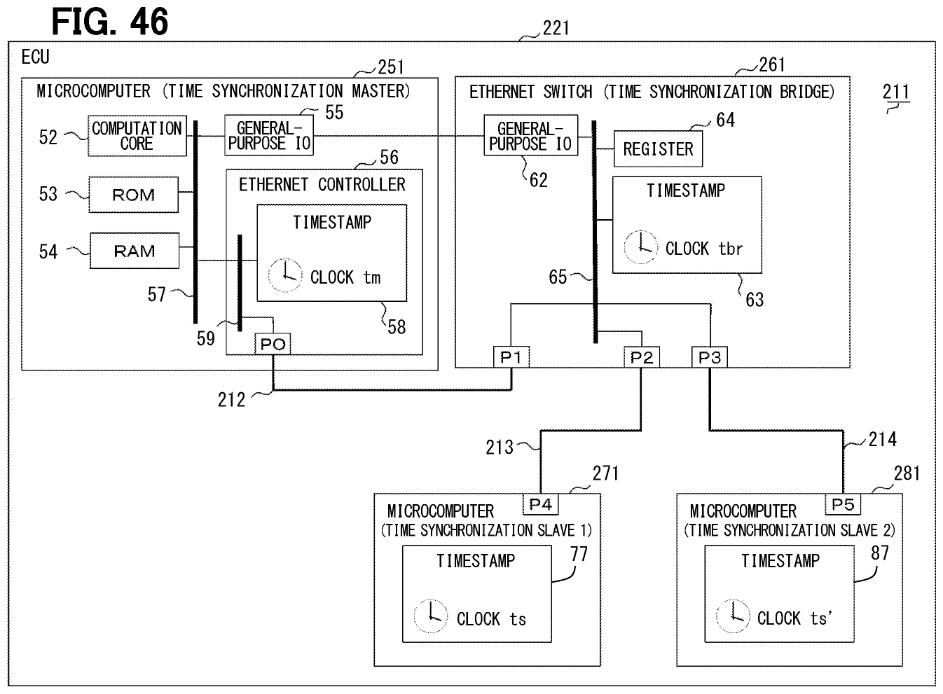

A sixth embodiment will be described with reference to FIG. 46. In the first embodiment, the time synchronization master, the time synchronization slave 1, and the time synchronization slave 2 are disposed in different ECUs 21, 31, and 41. In contrast, in the sixth embodiment, the time synchronization master, the time synchronization slave 1, and the time synchronization slave 2 are disposed in the same ECU.

As illustrated in FIG. 46, a time synchronization communication system 211 includes a microcomputer 251, an Ethernet switch 261, and microcomputers 271 and 281 as data communication systems in an ECU 221. The microcomputer 251, the Ethernet switch 261, and the microcomputers 271 and 281 have similar configurations to the microcomputer 51, the Ethernet switch 61, and the microcomputers 71 and 81 described in the first embodiment, and function as a time synchronization master, a time synchronization bridge, and time synchronization slaves 1 and 2, respectively.

The communication port P0 of the microcomputer 251 and the communication port P1 of the Ethernet switch 261 are connected via Ethernet 212. The communication port P2 of the Ethernet switch 261 and the communication port P4 of the microcomputer 271 are connected via Ethernet 213. The communication port P3 of the Ethernet switch 261 and the communication port P5 of the microcomputer 281 are connected via Ethernet 214.

As described above, according to the sixth embodiment, the following operational effects can be obtained. Even in the configuration in which the time synchronization master, the time synchronization bridge, and the time synchronization slaves 1 and 2 are disposed in the same ECU 221 in the time synchronization communication system 211, the time synchronization slave acquires the timestamp of the preceding message held in the register 64 from the time synchronization bridge before the timestamp of the subsequent message is held in the register 64, so that it is possible to avoid the occurrence of the trouble in the time management of messages in advance.

Although the configuration in which both the time synchronization slave 1 and the time synchronization slave 2 are disposed in the ECU 221 together with the time synchronization master and the time synchronization bridge has been exemplified above, either one of the time synchronization slave 1 and the time synchronization slave 2 may be disposed in the ECU 221 together with the time synchronization master and the time synchronization bridge. That is, some of the plurality of time synchronization slaves may be disposed in another ECU.

In addition, although the configuration in which the time synchronization master remotely controls the time synchronization bridge has been exemplified, the same applies to the configuration in which the time synchronization slave remotely controls the time synchronization bridge described in the fifth embodiment. That is, the microcomputer 151, the Ethernet switch 161, and the microcomputers 171 and 181 may be disposed in the same ECU.

### Seventh Embodiment

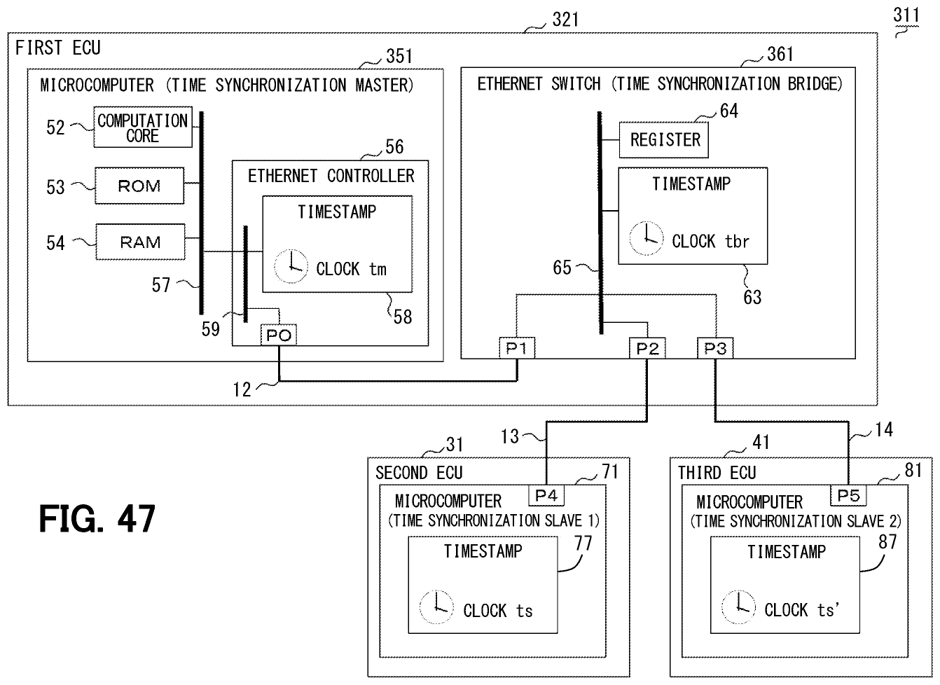

A seventh embodiment will be described with reference to FIG. 47. In the first embodiment described above, the general-purpose IO is used as a method in which the time synchronization master remotely controls the time synchronization bridge, but in the seventh embodiment, Ethernet is used as a method in which the time synchronization master remotely controls the time synchronization bridge.

As illustrated in FIG. 47, in a time synchronization communication system 311, a first ECU 321 includes a microcomputer 351 and an Ethernet switch 361. The microcomputer 351 has a configuration in which the general-purpose IO 55 is omitted from the microcomputer 51 described in the first embodiment, and the Ethernet switch 361 has a configuration in which the general-purpose IO 62 is omitted from the Ethernet switch 61 described in the first embodiment. In this case, the microcomputer 351 functioning as a time synchronization master writes and reads data to and from the register 64 by data communication conforming to the Ethernet communication protocol, and remotely controls the Ethernet switch 361 functioning as a time synchronization bridge.

As described above, according to the seventh embodiment, the following operational effects can be obtained. Even in the configuration in which the general-purpose IO is omitted from the time synchronization master and the time synchronization bridge in the time synchronization communication system 311, the time synchronization slave acquires the timestamp of the preceding message held in the register 64 from the time synchronization bridge before the timestamp of the subsequent message is held in the register 64, so that it is possible to avoid the occurrence of the trouble in the time management of messages in advance.

Although the configuration in which the time synchronization master remotely controls the time synchronization bridge has been exemplified, the same applies to the configuration in which the time synchronization slave remotely controls the time synchronization bridge described in the fifth embodiment. That is, the general-purpose IO 155 may be omitted from the microcomputer 151 and the general-purpose IO 162 may be omitted from the Ethernet switch 161, unlike the fifth embodiment.

### Eighth Embodiment

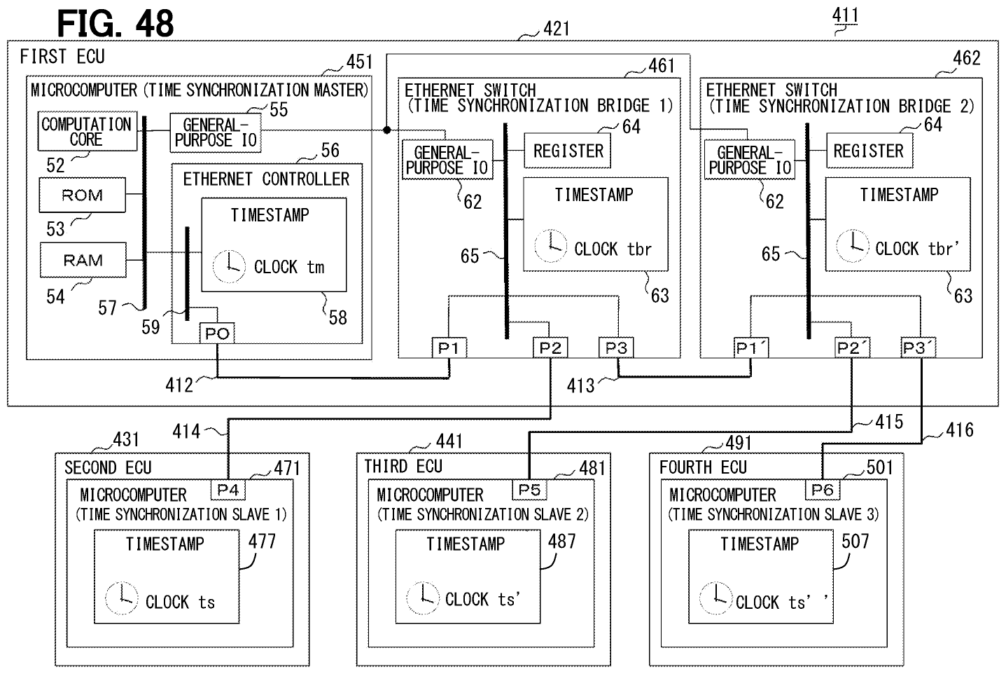

An eighth embodiment will be described with reference to FIG. 48. In the first embodiment described above, one time synchronization bridge is disposed, but in the eighth embodiment, a plurality of time synchronization bridges are arranged in cascade connection.

As illustrated in FIG. 48, a time synchronization communication system 411 includes a first ECU 421, a second ECU 431, a third ECU 441, and a fourth ECU 491. The first ECU 421 includes a microcomputer 451 and Ethernet switches 461 and 462. The second ECU 431 includes a microcomputer 471. The third ECU 441 includes a microcomputer 481. The fourth ECU 491 includes a microcomputer 501. The microcomputer 471 includes a timestamp section 477 that records the time by a timer that measures the clock ts. The microcomputer 481 includes a timestamp section 487 that records the time by a timer that measures the clock ts′. The microcomputer 451, the Ethernet switches 461 and 462, and the microcomputers 471 and 481 have similar configurations to the microcomputer 51, the Ethernet switch 61, and the microcomputers 71 and 81 described in the first embodiment, and function as a time synchronization master, time synchronization bridges 1 and 2, and time synchronization slaves 1 and 2, respectively. Furthermore, the microcomputer 491 includes a timestamp section 507 that records the time by a timer that measures a clock ts″, and functions as a time synchronization slave 3.

The communication port P0 of the microcomputer 451 and the communication port P1 of the Ethernet switch 461 are connected via Ethernet 412. The communication port P3 of the Ethernet switch 461 and a communication port P1″ of the Ethernet switch 462 are connected in cascade via Ethernet 413. The communication port P2 of the Ethernet switch 461 and the communication port P4 of the microcomputer 471 are connected via Ethernet 414. A communication port P2′ of the Ethernet switch 462 and the communication port P5 of the microcomputer 481 are connected via Ethernet 415. A communication port P3′ of the Ethernet switch 462 and a communication port P6 of the microcomputer 501 are connected via Ethernet 416.

The microcomputer 451 functioning as a time synchronization master remotely controls the Ethernet switch 461 functioning as a time synchronization bridge 1 and remotely controls the Ethernet switch 462 functioning as a time synchronization bridge 2. In the above configuration, the propagation delay time between the time synchronization master and the time synchronization bridge 1, the propagation delay time between the time synchronization slave 1 and the time synchronization bridge 1, the propagation delay time between the time synchronization slaves 2 and 3 and the time synchronization bridge 2, and the propagation delay time between the time synchronization bridge 1 and the time synchronization bridge 2 are calculated.

As described above, according to the eighth embodiment, the following operational effects can be obtained. Even in the configuration in which the plurality of time synchronization bridges are arranged in the time synchronization communication system 411, the time synchronization slave acquires the timestamp of the preceding message held in the register 64 from the time synchronization bridge before the timestamp of the subsequent message is held in the register 64, so that it is possible to avoid the occurrence of the trouble in the time management of messages in advance.

Although the configuration in which the time synchronization master remotely controls the time synchronization bridges 1 and 2 has been exemplified, the same applies to the configuration in which the time synchronization slave remotely controls the plurality of time synchronization bridges described in the fifth embodiment. That is, the first ECU 121 described in the fifth embodiment may include the time synchronization slave 1 and the time synchronization bridges 1 and 2, and the time synchronization bridges 1 and 2 may be connected in cascade.

### Ninth Embodiment

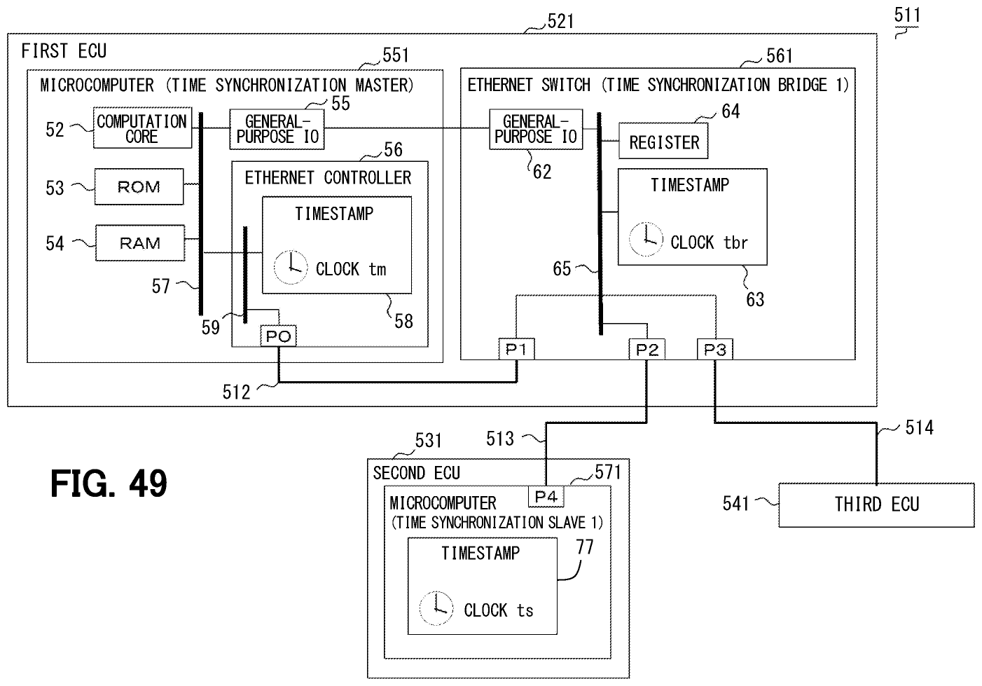

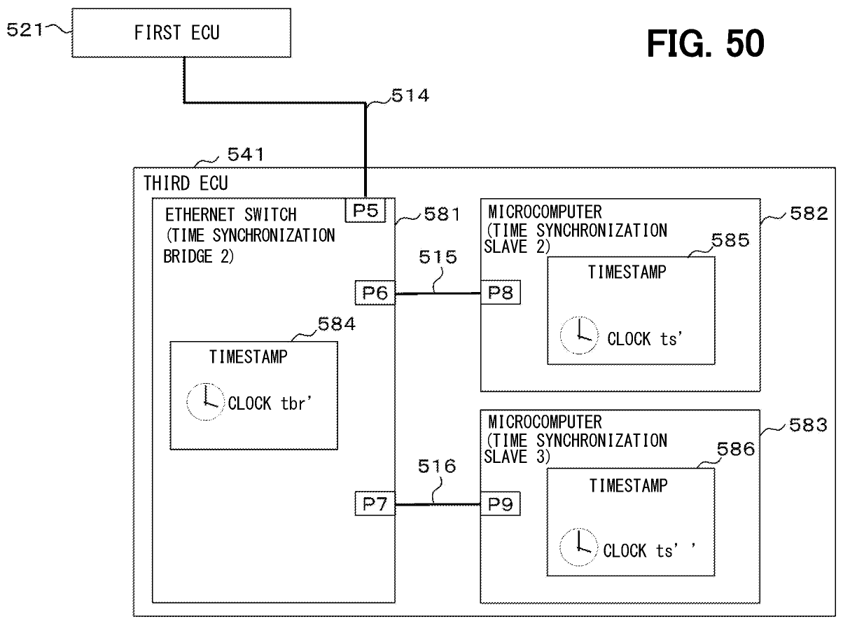

A ninth embodiment will be described with reference to FIGS. 49 to 50. In the eighth embodiment described above, the time synchronization bridges 1 and 2 are arranged in the same ECU, but in the ninth embodiment, the time synchronization bridges 1 and 2 are arranged in different ECUs.

As illustrated in FIGS. 49 to 50, a time synchronization communication system 511 includes a first ECU 521, a second ECU 531, and a third ECU 541. The first ECU 521 is, for example, an ECU that controls a plurality of ECUs. The third ECU 541 is, for example, an ECU that controls ADAS. The first ECU 521 includes a microcomputer 551 and an Ethernet 561. The second ECU 531 includes a microcomputer 571. The microcomputer 551, the Ethernet switch 561, and the microcomputer 571 have similar configurations to the microcomputer 51, the Ethernet switch 61, and the microcomputer 71 described in the first embodiment, and function as a time synchronization master, a time synchronization bridge 1, and a time synchronization slave 1, respectively.

The third ECU 541 includes an Ethernet switch 581 and microcomputers 582 and 583. The Ethernet switch 581 includes a timestamp section 584 that records the time by a timer that measures a clock tbr′, and functions as the time synchronization bridge 2. The microcomputer 582 includes a timestamp section 585 that records the time by a timer that measures the clock ts′, and functions as the time synchronization slave 2. The microcomputer 583 includes a timestamp section 586 that records the time by a timer that measures the clock ts″, and functions as the time synchronization slave 3.

The communication port P0 of the microcomputer 551 and the communication port P1 of the Ethernet switch 561 are connected via Ethernet 512. The communication port P2 of the Ethernet switch 561 and the communication port P4 of the microcomputer 571 are connected via Ethernet 513. The communication port P3 of the Ethernet switch 561 and the communication port P5 of the Ethernet switch 581 are connected via Ethernet 514. The communication port P6 of the Ethernet switch 581 and a communication port P8 of the microcomputer 582 are connected via Ethernet 515. A communication port P7 of the Ethernet switch 581 and a communication port P9 of the microcomputer 583 are connected via Ethernet 516.

The time synchronization master does not recognize the presence of the time synchronization slaves 2 and 3 and handles the time synchronization bridge 2 as a time synchronization slave, thereby distributing the reference time to the time synchronization bridge 2. The time synchronization bridge 2 acts as the time synchronization master in the third ECU 541 to distribute the reference time distributed from the time synchronization master to the time synchronization slaves 2 and 3.

As described above, according to the ninth embodiment, the following operational effects can be obtained. Even in the configuration in which the time synchronization bridges 1 and 2 are arranged in different ECUs in the time synchronization communication system 511, the time synchronization slave acquires the timestamp of the preceding message held in the register 64 from the time synchronization bridge before the timestamp of the subsequent message is held in the register 64, so that it is possible to avoid the occurrence of the trouble in the time management of messages in advance.

### Other Embodiments

Although the present disclosure has been described in accordance with examples, it is understood that the present disclosure is not limited to the examples and structures. The present disclosure also includes various modifications and modifications within an equivalent range. In addition, various combinations and modes, and other combinations and modes including only one element, more elements, or less elements are also within the scope and idea of the present disclosure.

In the configuration in which the time synchronization master remotely controls the time synchronization bridge, transmission control may be executed using time synchronization messages other than the propagation delay measurement response message and the time synchronization message transmitted by the time synchronization master as the first message and the second message. In the configuration in which the time synchronization slave remotely controls the time synchronization bridge, transmission control may be executed using time synchronization messages other than the propagation delay measurement request message transmitted by the time synchronization slave as the first message and the second message.

Although the configuration in which the time synchronization master or the time synchronization slave and the time synchronization bridge are connected via Ethernet has been exemplified, a communication network other than Ethernet may be adopted, and the time synchronization master or the time synchronization slave and the time synchronization bridge may be connected via, for example, a controller area network (CAN) (registered trademark) or FlexLay (registered trademark). Alternatively, a plurality of Ethernet, CAN, and FlexLay may be combined.

The data communication system for a vehicle mounted on a vehicle is exemplified, and the microcomputer or the Ethernet switch built in the ECU is exemplified as a node. However, the present disclosure may be applied to a data communication system other than in-vehicle use.

The control section and the method thereof described in the present disclosure may be implemented by a dedicated computer provided by configuring a processor and a memory programmed to execute one or a plurality of functions embodied by a computer program. Alternatively, the control section and the method thereof described in the present disclosure may be implemented by a dedicated computer provided by configuring a processor with one or more dedicated hardware logic circuits. Alternatively, the control section and the method thereof described in the present disclosure may be implemented by one or more dedicated computers configured by a combination of a processor and a memory programmed to execute one or a plurality of functions and a processor configured with one or more hardware logic circuits. The computer program may be stored in a computer-readable non-transition tangible recording medium as an instruction executed by a computer.

What is claimed is:

1. A time synchronization communication system in which a plurality of nodes perform time synchronization via a communication network, the plurality of nodes comprising:
a time synchronization end station including
a first time recording section that records a time measured by a first timer at a time of transmission and reception of a message, and
a message transmission control section that controls transmission of the message; and
a time synchronization bridge including
a second time recording section that records a time measured by a second timer at a time of transmission and reception of a message, and
a time holding section that holds a time recorded by the second time recording section, the time synchronization bridge relaying a message transmitted to and received from the time synchronization end station,
the time synchronization end station remotely controls the time synchronization bridge, and
after transmitting a first message to the time synchronization bridge, the message transmission control section transmits a second message to the time synchronization bridge on condition that the time synchronization end station has acquired, from the time synchronization bridge, a time held in the time holding section as the first message is received by the time synchronization bridge.

2. The time synchronization communication system according to claim 1, wherein
the message transmission control section is capable of measuring a predetermined time during which the time synchronization end station is capable of acquiring, from the time synchronization bridge, a time held in the time holding section as the first message is received by the time synchronization bridge, starts measuring the predetermined time and transmits the first message to the time synchronization bridge, and prohibits transmission of the second message to the time synchronization bridge while measuring the predetermined time.

3. The time synchronization communication system according to claim 2, wherein
the message transmission control section individually measures a predetermined time for each of a plurality of first messages.

4. The time synchronization communication system according to claim 1, wherein
the message transmission control section is capable of setting a transmission permission flag indicating whether to transmit a message, sets the transmission permission flag to not-transmittable, transmits the first message to the time synchronization bridge, prohibits transmission of the second message to the time synchronization bridge while setting the transmission permission flag to not-transmittable, and sets the transmission permission flag to transmittable after the time synchronization end station acquires, from the time synchronization bridge, a time held in the time holding section as the first message is received by the time synchronization bridge.

5. The time synchronization communication system according to claim 4, wherein
the message transmission control section individually sets a transmission permission flag for each of a plurality of first messages.

6. The time synchronization communication system according to claim 1, wherein
the time synchronization end station includes a time synchronization master that distributes a reference time to a time synchronization slave.

7. The time synchronization communication system according to claim 1, wherein
the time synchronization end station includes a time synchronization slave that estimates a clock of a time synchronization master that distributes a reference time.

8. A time synchronization end station included as a node in a time synchronization communication system together with a time synchronization bridge including a second time recording section that records a time measured by a second timer at a time of transmission and reception of a message and a time holding section that holds the time recorded by the second time recording section and relaying a message transmitted to and received from the time synchronization end station, the time synchronization end station remotely controlling the time synchronization bridge, the time synchronization end station comprising:
a first time recording section that records a time measured by a first timer at the time of transmission and reception of a message; and
a message transmission control section that controls transmission of the message,
wherein
after transmitting a first message to the time synchronization bridge, the message transmission control section transmits a second message to the time synchronization bridge on condition that the time synchronization end station has acquired, from the time synchronization bridge, a time held in the time holding section as the first message is received by the time synchronization bridge.

9. A non-transitory computer readable storage medium storing a message transmission control program causing a time synchronization end station included as a node in a time synchronization communication system together with a time synchronization bridge including a second time recording section that records a time measured by a second timer at a time of transmission and reception of a message and a time holding section that holds a time recorded by the second time recording section and relaying a message transmitted to and received from the time synchronization end station, the time synchronization end station remotely controlling the time synchronization bridge to execute:
a first message transmission procedure to transmit a first message to the time synchronization bridge; and
a second message transmission procedure to transmit a second message to the time synchronization bridge on condition that the time synchronization end station has acquired, from the time synchronization bridge, a time held in the time holding section as the first message is received by the time synchronization bridge.
